(19) United States
(12) Patent Application Publication
(10) Pub. No.: US 2024/0336007 A1
(43) Pub. Date: Oct. 10, 2024

(54) ADDITIVE MANUFACTURING OF TUNABLE POLYMERIC 3D ARCHITECTURES FOR MULTIFUNCTIONAL APPLICATIONS

(71) Applicant: THE REGENTS OF THE UNIVERSITY OF CALIFORNIA, Oakland, CA (US)

(72) Inventors: David Kisailus, Irvine, CA (US); Devis Montroni, Irvine, CA (US)

(21) Appl. No.: 18/579,127

(22) PCT Filed: Aug. 18, 2022
(86) PCT No.: PCT/US22/75111

§ 371 Date: Jan. 12, 2024

Related U.S. Application Data
(60) Provisional application No. 63/235,462, filed on Aug. 20, 2021.

(51) Int. Cl. B29C 64/188; B29C 64/106; B29C 64/209; B29C 64/255; B29C 64/393; B29K 105/00; B29K 105/12; B33Y 10/00; B33Y 30/00; B33Y 50/02; B33Y 70/00

(52) U.S. Cl. CPC B29C 64/188; B29C 64/106; B29C 64/209; B29C 64/255; B29C 64/393; B33Y 10/00; B33Y 30/00; B33Y 50/02; B33Y 70/00; B29K 2105/0073; B29K 2105/12; B29K 2995/0056

(57) ABSTRACT

The present invention relates to a process for additive manufacturing of polymeric nano-micron sized fiber-based material. Biopolymers such as chitin and chitosan may be used to make useful and green materials. Tuning the printing properties can modulate mechanical, thermal, and electrical properties of the final material. Different methods to tune properties include controlling the solution chemistry and the flow processing (i.e., fiber extrusion via direct ink write printing and possible electrospinning). The primary application is to make 3D materials of multifunctional fibers that can be utilized in structural composites, textiles, biomedical scaffolds, batteries, catalytic or physical and chemical separation membranes.

### CROSS-REFERENCES TO RELATED APPLICATIONS

This application claims benefit of U.S. Provisional Application No. 63/235,462 filed Aug. 20, 2021, the specification(s) of which is/are incorporated herein in their entirety by reference.

### STATEMENT REGARDING FEDERALLY SPONSORED RESEARCH OR DEVELOPMENT

This invention was made with government support under Grant No. FA9550-15-1-0009 awarded by AFOSR. The government has certain rights in the invention.

### FIELD OF THE INVENTION

The present invention describes the synthesis of 3D printed scaffolds with a customized hierarchical 3D architecture, providing control from nano- to macro-scale features, for multiple applications, including a process to obtain printed chitinous scaffolds. This can be used as a standalone structure for structural uses, where biodegradation or biocompatibility can be implemented, or as a template to enable formations of multiphasic composite structures. These scaffolds can be applied for: (i) energy conversion or storage devices (i.e., fuel cell catalysts or Li-ion battery cathodes/anodes), (ii) biomedical implantable materials, (iii) structural materials—i.e., automotive, aerospace, or infrastructural, (iv) environmental remediation such as water purification—i.e., a membrane used for heavy metal absorption or photocatalytic reactors, (v) a broad variety of templating on biological scaffolds in 3D, and (vi) guidance for directionally-controlled reactions.

### BACKGROUND OF THE INVENTION

The architecture of materials is a crucial aspect in material science. Despite identical composition, different architectures can lead to significant changes in the material properties, such as structural or mechanical ones, chemical or physical adsorption, or photonic, crack, or stress propagation. In addition, these architectures provide anisotropic scaffolds, which can lead to directionally-controlled reactions. The architecture of a material can be addressed at different levels, from the nano- to the macro-scale. Many different manufacturing processes have addressed this issue. Most of them present limits in being scaled up due to economical (i.e., freeze drying) or technical (i.e., magnetic field alignment) limitations. Moreover, the architectural features are usually addressed in a limited dimensional scale. Thus, there is a need to develop scalable manufacturing solutions to provide control over a materials' architecture at different length scales, while still maintaining the ability to integrate multifunctionality, and reduce both cost and environmental impact.

Among biopolymers, mostly cellulose or collagen based materials were prepared using related approaches and the final scaffold mostly addresses medical fields. These prior works mostly use mixtures of synthetic and biopolymers, or biopolymers modified to allow UV curing or specific interaction leading to cross-linking. Highly hydrated materials can also be printed by using highly swellable biopolymers, such as alginate or agarose, or by crosslinking highly viscous solutions. In order to obtain gel-like materials, the conditions need to be specifically optimized based on the chemistry of the material itself.

Exploiting the natural biocompatibility of biopolymers, the scaffolds produced mainly found applications in the medical field. Biopolymers, compared to synthetic ones, also allow access to other important features. One of these is the possibility to have biomacromolecules (e.g., proteins) able to specifically interact with them. These biomolecules have been used to tag and localize biopolymers in complex mixtures (such as biological environments) but their use to functionalize materials has never been described before. The application of these tools allows the functionalization of a material surface without inducing any change in its chemical structure, avoiding compromising the architectural integrity of the material from the macro- to the nanoscale (i.e., crystallinity). In synthetic polymers, adsorption or chemical functionalization are the only routes to introduce new functionalities on an already manufactured material.

Biopolymers have already been exploited as a green and sustainable alternative to synthetic polymers to obtain carbonized matrices. Graphite-metal core-shell structures have been successfully synthesized using chitin as a carbon source during carbonization. Other biopolymers have been applied to produce carbon materials without adding metals to them. This general approach has been widely applied in literature to obtain functional materials but the use of a polymeric scaffold with controlled architecture in order to template the particle, fiber, film growth, all while maintaining mechanical integrity is missing. Up to now, only the carbonization condition (temperature, atmosphere, etc.) has been optimized to obtain materials suitable for a specific application.

Inducing a shear stress on a solution prior to solidification, usually by solvent elimination, to control the alignment in materials has been widely studied to control the material organization at the nano- and micrometric level. Generally, this is obtained by extruding a material through a needle yielding a macroscopic material, either a 1D fiber or a 3D organized material, if combined with 3D printing. This approach has been used on different materials, such as nanocrystals or polymers (both synthetic and biogenic) solutions, to produce matrices with high fibrillar alignment along the extrusion direction. In previous works, the angle of the fibril alignment has been partially tuned by applying a spinning motion to the nozzle. Moreover, in 3D printing, the geometry of the printed material strongly influenced the final material properties, thus adding an additional level to the hierarchical structure of the material.

Using this approach, hydrated materials can also be printed by using swellable polymers, such as alginate or agarose, by rapid crosslinking of highly viscous solutions, or adding to the mixture a self-assembling mineral phase that acts as a support. In order to obtain a gel-like material, the conditions need to be specifically optimized based on the chemistry of the components. A general approach to obtain highly swelled materials from polymers has not been reported.

Most extrusion processes target synthetic polymers, due to their easy handling and their specific chemical composition and size (i.e., average molecular weight). Conversely, biopolymers are generally less utilized here. Mostly cellulosic (usually nanocrystals) or collagen-based materials have been prepared using this approach, exploiting their biocompatibility for medical applications. A mixture of synthetic and bio-polymers, or chemically-modified biopolymers were frequently used to allow for UV curing or other specific interactions leading to cross-linking. Pure biopolymers have rarely been utilized as the only material or major component of the mixture. Amongst these natural polymers, chitin has scarcely been investigated as the primary print media and has never been used as a single component.

### BRIEF SUMMARY OF THE INVENTION

It is an objective of the present invention to provide methods that allow for additive manufacturing of tunable polymeric materials, as specified in the independent claims, with potential translation to ceramic and metallic materials using the polymer as a template. Embodiments of the invention are given in the dependent claims. Embodiments of the present invention can be freely combined with each other if they are not mutually exclusive.

In the present invention, an additive manufacturing process, direct ink write printing, was developed to control different architectural features from the nano- to the millimeter scale (i.e., diameter and fibrillar alignment) during extrusion to obtain chitin-based gel scaffolds. The approach utilized can be expandable to any polymeric material to obtain materials with a single hydrated component. Chitin was chosen as a polymer as this biopolymer grants different advantages since it is mechanically robust and can self-assemble into crystalline nanofibrils. Moreover, the biocompatibility of this polymer promotes its use as material for medical applications, from drug delivery to wound healing and regenerative medicine.

Manufacturing processes that enable control of the average polymer alignment are described in literature. These processes usually rely on synthetic polymers or composite with a determined percentage of nanocrystals of chitin. The biopolymers obtained using the methods described herein represent a greener alternative, since they are completely biodegradable and can be obtained by renewable resources. In addition, the presence of chitin enables the use of proteins with both chitin binding function and secondary domains to enable binding to other ions, particles and bulk materials. In some embodiments, proteins bound to the chitin can be utilized to act to nucleate ions (e.g., water purification), nanoparticles, organic and biological materials (e.g., enzymes). Furthermore, the methods described herein can be implemented for both biopolymers as well as synthetic polymers.

Compared to other processes, the methods described herein are safer and cheaper since they are mostly performed in water and could be completely performed in aqueous solvents. Another advantage of printing in aqueous media is the ability to tune the porosity of the fiber, which then controls the volume fraction of secondary materials that could be added to these scaffolds. The material obtained is also completely biocompatible and can be easily applied in medicinal or alimentary applications. In some aspects, the process can be scaled up, e.g., for commercialization.

Here, the inventors have developed a process to 3D print a polymeric nano-micron sized structured material (e.g., primarily biopolymers that can be sourced from waste materials and repurposed into a useful and green engineered material, e.g., chitin, chitosan, but can also be others like keratin, cellulosic, collagenous, etc. if needed). Tuning the printing can be used to control the dimensionality of the resulting materials (e.g. 0D particles, 1D fibers or tubules, 2D thin or thick films, 3D conformational structures) as well as modulate mechanical, thermal, and electrical properties by controlling the solution chemistry and the flow processing (i.e., fiber extrusion via direct ink write printing, possible electrospinning, thin film casting, etc.). The primary application is to make 3D materials of multifunctional fibers that can be utilized in structural composites, textiles, biomedical scaffolds, batteries, catalytic or physical and chemical separation membranes.

According to some embodiments, the process involves dissolving any biopolymer-based structures (e.g., purified chitin from crab or shrimp shells or using store-bought purified biopolymer) with a specific solvent until desired solution parameters are obtained (e.g., viscosity or concentration). Then, the viscous solution is fed through a nozzle with controlled diameter and pressure into a vessel typically containing an antisolvent that will induce precipitation. Modulating not only the diameter, but also the pressure, viscosity of the solution (i.e., via concentration of polymer, molecular weight, molecular weight distribution, polymer architecture—backbone and side chain size and conformation), solvent and printing media (solvent or substrate into which fibers are printed), can be used to tune the resulting hierarchical features within the printed materials. Also, the printed media does not have to be fibrous, as it can also be printed as a thin film, for example, which depends on the solidification process used (whether injection in a non-solvent or solvent evaporation).

In some embodiments, the material could be exposed to chitin-binding molecules which would organize in a specific pattern, following the material architecture. These molecules might carry specific chemical groups that could introduce new properties on the material itself. On the other hand, the material could be deposited along with metal ions and successfully carbonized. During this process, metal nanoparticles would form, following the architecture of the scaffold material (which could also affect the shape and size of the particles obtained). These final materials can find application in energy storage, catalysis, sensor engineering, or water purification.

The possibility to control these parameters has a strong influence on the final properties and thus, utility of the material itself. Tunable properties include mechanical response (stiffness, strength, toughness), porosity (pore size/distribution), and chemistry of interfaces. These last two parameters allow control of the specific type and quantity of material that can be implemented into these scaffolds. The material could be used as it is, finding application in structural fields, or further modifications can be applied to enable use in medical, energy, or environmental applications.

Without wishing to limit the present invention, the use of biopolymers represents a green alternative (both biodegradable and obtained from a sustainable source) to synthetic polymers (although synthetic polymers can be printed in this way) and the process used to control their architectural parameters could be easily scaled up to mass production. The method of the present invention controls both polymer alignment and its macro-architecture. The manufacturing process presents numerous parameters that can be used to tune different architectural features simultaneously, allowing the material to be customized in one single step. Since many different variables can be controlled independently, the customization of the final material is extremely flexible.

Without wishing to limit the present invention, the use of a biopolymer, such as chitin, allows access to biological tools, such as chitin-binding proteins, which can bind to the scaffold in an arrangement coherent with the fibrils' architecture. Other architectural features or material properties could be further customized by guiding the interaction between the two phases of this polymer/protein composite material. The biomacromolecules used might also be used to introduce new functionalities in the material itself. Such interaction could not be achieved by using synthetic polymers, which only rely on chemical functionalization or adsorption to introduce new properties or customize the material ones.

Without wishing to limit the present invention, the use of chitin-binding proteins, compared to classical chemical functionalization, represents a green alternative with a higher yield and specificity that can be completely performed in aqueous solvents. Whether the functionalities introduced are able to interact with metal ions, the composite can be used to nucleate nanoparticles, nanorods, and thin films of many possible mineral phases or organic materials. The controlled geometrical distribution of the binding sites, due to the architecture of the matrix and the protein distribution, can introduce a strong control over nucleation and growth of the particles. This control can result in a fine tuning over alignment, size, shape, and polymorphism of the final particles.

In some embodiments, the scaffold obtained could be carbonized with or without metal ions. Compared to many synthetic polymers, such as polyacrylonitrile, chitin carbonization does not require stabilization at low temperatures, meaning it can be performed with less energy requirements. Moreover, the carbon material obtained may be rich in nitrogen, which has been observed to have a positive influence when applied in electronics. The carbonization of polymers with metal ions has been observed to induce the formation of metal nanoparticles due to ion migration in the sample and, depending on the metal used, the consequent formation of graphite due to metal catalysis. The matrix already presents a controlled fibril alignment, with a consequent control over crystallinity of the polymer. The more amorphous regions of the material can degrade more easily compared to more crystalline ones. The first ones would give the metal particles nutrients for graphite catalysis while the second should help template the particle formation. As a consequence, the initial control over fibril alignment would result in a control over the migration of metal ions, and consequently nucleation and growth of the nanoparticles or other nanostructures, and the nutrient flux responsible for graphitization processes. Such control could address a major problem in nanoparticle-doped materials concerning the control of alignment, size, shape, and polymorphism of the final particles. Moreover, it would also allow the customization of the entity of the graphitization process, allowing tuning of the electrical and thermal behavior of the material.

One of the unique and inventive technical features of the present invention is the ability to use biopolymers such as chitin for additive manufacturing. Without wishing to limit the invention to any theory or mechanism, it is believed that the technical feature of the present invention advantageously provides for methods to produce materials that may be biocompatible for medicinal purposes and materials that are biodegradable. None of the presently known prior references or work has the unique inventive technical feature of the present invention. For example, biopolymers such as chitin are difficult to work with because they are not easy to solubilize, thus these types of materials are avoided in additive manufacturing.

According to some embodiments, the present invention features an additive manufacturing method to produce a biopolymeric material with tunable properties. The method may comprise dissolving a biopolymer in a solvent to make a biopolymer solution comprising biopolymer molecules, pre-aligning the biopolymer molecules in solution, depositing the biopolymer solution, and solidifying the biopolymer, thereby forming the biopolymeric material with tunable properties. One or more conditions from pre-alignment, deposition, or solidification are used to tune properties of the biopolymeric material. The tunable properties of the biopolymeric material may include, but are not limited to, shape or morphology, fibril alignment, surface rugosity, density, porosity, exposed surface, crystallinity, solvent content, mechanical toughness, flexural stiffness, wear resistance, thermal resistance or conductance, electrical resistance or conductance, and/or light attenuation or conduction.

In one embodiment, the biopolymer solution is deposited into a counter solvent or a supersaturated gas to solidify the biopolymer. In another embodiment, the solvent is evaporated to solidify the biopolymer solution. Heat or pressure can be used to evaporate the solvent.

In some embodiments, pre-alignment may be achieved by tuning a concentration of the biopolymers and/or the solvent, tuning a pressure applied to force the biopolymer solution through a nozzle, tuning a diameter of the nozzle and/or a geometry of the nozzle, or a combination thereof. In other embodiments, the biopolymer molecules are pre-aligned in solution using shear flow, pressure, modified ionic strength of the solvent, or modified pH of the solvent. In some embodiments, the biopolymer solution is deposited using 3D printing, extrusion, electrospinning, spin-coating, casting, or dip coating.

In some embodiments, the one or more conditions comprise chemical or physical properties of the biopolymer, properties of the biopolymer solution, geometry or mechanics of the additive manufacturing process, or a combination thereof. The chemical or physical properties of the biopolymer may include, but are not limited to, molecular weight, molecular weight distribution, molecular branching, crystallite dimension, polymorphism, crystallinity, degree of substitution, or polarity. In other embodiments, the properties of the biopolymer solution comprise viscosity of the solution or concentration of the biopolymer. The geometry or mechanics of the additive manufacturing process may include, but are not limited to, geometry of a nozzle, geometry of an extrusion hole of the nozzle, patterning of an inside surface of the nozzle, motion of the nozzle, pressure, or rate of extrusion.

In other embodiments, the method may comprise additional modification of the biopolymeric material. Non-limiting examples of the additional modification include dehydration, carbonization, adsorption, binding molecules to the material, or performing solvent exchange. In some embodiments, the additional modification is performed before or during deposition of the biopolymer solution or after solidification of the biopolymer. In some embodiments, modifying the biopolymeric material can form metallic, ceramic, polymer, biological materials, or hybrid materials. The biopolymeric material can be used as a template or scaffold upon which metal-based precursors can be deposited and then treated to convert them to metals, metal oxides/carbides/nitrides, etc.

In some other embodiments, the biopolymer solution further comprises additional components. The additional components may include, but are not limited to, another polymer or biopolymer, biomacromolecules, biopolymer binding molecules, inorganic or organic precursors, clusters, nanoparticles, nanorods, nanotubules, thin sheets, thin films, or a combination thereof.

In some aspects, the biopolymer binding molecules are functionalized. The biopolymer binding molecules can be used as a carrier of functionalization to obtain functional biopolymer based materials. In other aspects, the biopolymer binding molecules can tune mechanical properties of a polymeric scaffold. In some embodiments, the biopolymer binding molecules control assembly and organization of a biopolymer by driving specific protein-protein or protein-polymer interactions. In other embodiments, the functionalized biopolymer binding molecules, both organized in a specific pattern or not, control formation of a mineral phase on a biopolymer-based scaffold.

In some embodiments, architectural features in a biopolymeric scaffold are used to control binding, assembly and orientation of biopolymer binding molecules onto it. In other embodiments, architectural features in a polymeric scaffold may be used to control nucleation, growth and organization of inorganic nanoparticles during carbonization, or to control material graphitization during carbonization. Controlled geometry of the scaffold architecture is used to control diffusion of precursors, for graphite or nanoparticle formation, in a polymeric scaffold during carbonization. In some embodiments, carbonization of aligned scaffolds results in mechanically stable carbon materials.

In other embodiments, the methods described herein can be expanded to inorganic polymers/inorganic materials, and are not limited to just biopolymers. For example, in some embodiments, the material can be used to direct ink write high molecular weight inorganic polymers that can align and then be converted to metals, metal oxides/carbides/nitrides, etc. In some other embodiments, the materials described herein can be used to form metallic, ceramic, polymer, biological materials, or hybrid materials.

Any feature or combination of features described herein are included within the scope of the present invention provided that the features included in any such combination are not mutually inconsistent as will be apparent from the context, this specification, and the knowledge of one of ordinary skill in the art. Additional advantages and aspects of the present invention are apparent in the following detailed description and claims.

### BRIEF DESCRIPTION OF THE SEVERAL VIEWS OF THE DRAWING(S)

The features and advantages of the present invention will become apparent from a consideration of the following detailed description presented in connection with the accompanying drawings in which:

FIG. 1 shows a schematic of the manufacturing of the material.

FIG. 2 is a schematic representation of the extrusion setup showing all the possible control variables, where fibril alignment is due to shear stress along the deposition process.

FIG. 3A shows an image of direct deposition of chitin in water.

FIG. 3B shows an SEM image of the printed material.

FIG. 3C shows an SEM image of a section of the printed material.

FIG. 3D shows a printed pattern on a glass slide obtained by solvent evaporation on a 60° C. heated stage.

FIG. 3E shows an SEM image of the printed pattern on the slide glass.

FIG. 3F shows an SEM image of a section of the printed pattern on the slide glass.

FIG. 4 shows images of dehydrated printed material using different initial solution conditions. The materials were printed using a 27 G cylindrical nozzle, 100 kPa, and water as a counter-solvent.

FIG. 5 shows images of different fibril alignment, and nano-porosity observed in samples prepared using a conical or cylindrical nozzle. Each scaffold reported was printed using a 1% HFIP solution of chitin injected in water. The printing direction is always from top to bottom in all of the images.

FIG. 6 shows images of different fibril alignment along the pressure range studied. Two cylindrical nozzle inner diameters (NIDs) were tested. The printing direction is always from top to bottom in all of the images.

FIG. 7 shows images of different surface morphologies observed at the microscale on samples prepared using different conditions of printing. For each condition, the nozzle internal diameter (NID), pressure applied, and nozzle geometry are reported, when not specified, a cylindrical shape of the nozzle was used. The printing direction is always from top to bottom in all images.

FIG. 8 shows images of chitin extruded into different counter-solvents using a 27 G cylindrical nozzle and 100 kPa of pressure.

FIG. 9 shows the water content of the matrices printed by direct injection of the 1% HFIP solution in water.

FIG. 10A shows the wet diameters for the gel fibers obtained using the different nozzles (number of measures per condition, N≥6). For each condition, the average value is reported above each histogram column.

FIG. 10B shows the percent water content measured for gel fibers printed with the different nozzles (number of samples per condition, N≥2). For each condition, the average value is reported above each histogram column.

FIG. 11 shows optical micrographs of the wet gel fibers (first column), and SEM micrographs showing the entire fiber width at low magnification (inset, second column), the surface at intermediate magnification (second column), and the relative chitin fibril alignment at high magnification (third column) of the samples obtained using the different nozzles. The arrows show the fiber extrusion direction (second column, inset) and the calculated chitin fibril alignment direction (third column). Segments in the central column highlight distances between wrinkles in printed fibers.

FIGS. 12A-12C show results of mechanical tensile tests on the wet fibers. Different mechanical parameters are reported for each of the printing conditions: (FIG. 12A) max stress; (FIG. 12B) max strain; (FIG. 12C) Young's modulus. Number of samples per condition, N≥6. For each condition the average value is reported above each histogram column.

FIG. 12D shows representative stress-strain profiles of the gel fibers.

FIGS. 13A-13B is an evaluation of the effect of the fiber gels (22 G and 27 G) on cell cultures. FIG. 13A shows cell proliferation determined using the Cell Counting Kit-8 (CCK8) viability assay (number of samples per condition, N=3). FIG. 13B shows optical microscope images of MCF-7 cells grown in the presence or absence of the gels in a 48 well plate for 144 hours. For each condition, a lower magnification image (left) is reported, with a boxed section highlighting where the higher magnification images (right) were taken. Scale bars: 200 μm.

FIGS. 14A-14B show images of examples of microporosity tuned controlling the air bubble concentration in solution (scale bar: 200 μm).

FIGS. 15A-15B show a sample obtained by solvent evaporation before and after carbonization.

### DETAILED DESCRIPTION OF THE INVENTION

According to some embodiments, the present invention addresses primarily the manufacturing of biopolymeric materials including, but not limited to, pure chitinous materials, such as chitin and chitosan, or cellulose, lignin, collagen, keratin, silk fibroin, polynucleotides, etc. In other embodiments, the process can be extended to synthetic polymers (i.e., polyethylene, polyacrylonitrile, polycarbonate, polytetrafluoroethylene, etc.) or any blend of the previous cited classes of materials (i.e., chitin and polyacrylonitrile mixtures).

Biopolymers represent a green alternative to synthetic polymers commonly used for analogue applications. Moreover, pure biopolymeric materials (such as chitin) are difficult to handle and the processes used to control their architecture are usually difficult to scale up, due to economic or technical reasons. This process enables the fine control of different parameters in the architecture, texture, and crystallinity of these matrices, as pure material or mixed with additives, while maintaining the potential for scale up.

The process described herein has been primarily addressing the manufacturing of chitin/chitosan in order to obtain customized materials for diverse applications. The following description of the manufacturing will be mostly focused on this biopolymer but can be extended to all the classes of polymers previously mentioned.

Without wishing to limit the present invention to a particular theory or mechanism, the process allows for customization of the properties and architecture of a biopolymeric material by pre-aligning a solution before inducing solidification. The solidification might occur by different processes, such as assembly, precipitation, crystallization, or dehydration (including solvent evaporation), leading to the final structure of the material.

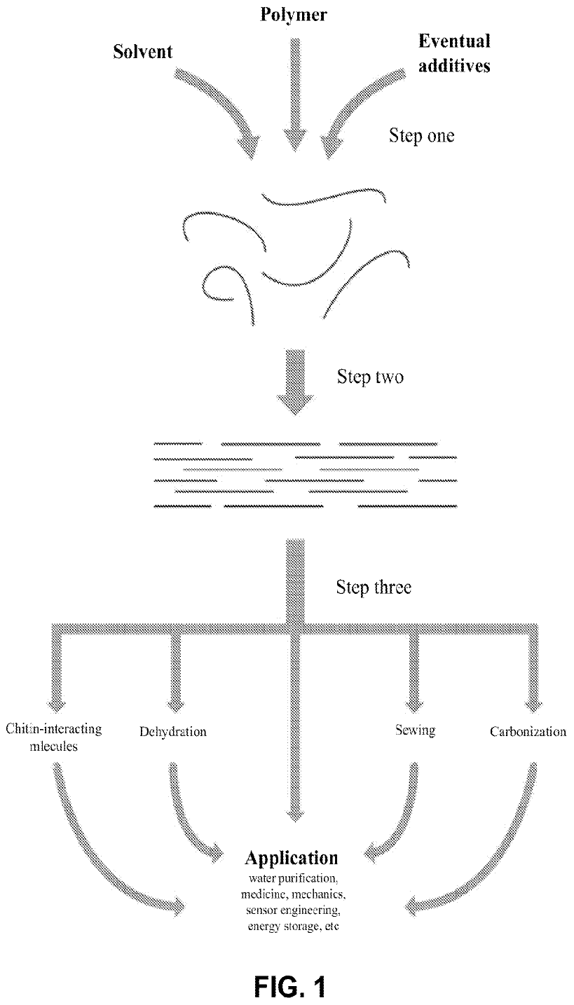

As shown in FIG. 1, the process can be summarized in different steps: i) biopolymer dispersion preparation, ii) biopolymer manufacturing, and iii) eventual additional manufacturing, which may include dehydration, carbonization, adsorption or binding of molecules, solvent exchange, etc.

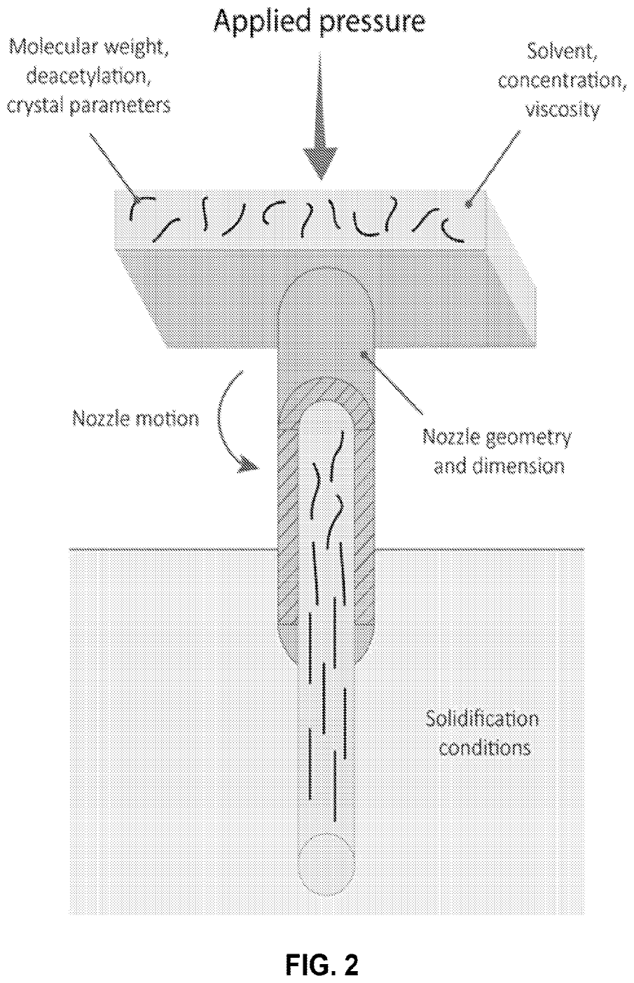

Referring to FIG. 2, according to some embodiments, the present invention features an additive manufacturing method to produce a biopolymeric material with tunable properties. The method may comprise: a) dissolving a biopolymer in a solvent to make a biopolymer solution comprising biopolymer molecules; b) pre-aligning the biopolymer molecules in solution; and c) depositing the biopolymer solution into a vessel containing a counter solvent or a supersaturated gas to solidify the biopolymeric material, thereby forming the biopolymeric material with tunable properties. In some embodiments, one or more conditions used for the pre-alignment, deposition, or solidification steps are used to tune properties of the final material. Non-limiting examples of the biopolymer include chitin, chitosan, keratin, alginate, or agarose.

According to other embodiments, the present invention features a method for producing a biopolymeric substrate with tunable properties. The method may comprise: a) dissolving a biopolymer in a solvent to make a biopolymer solution comprising biopolymer molecules; and b) pre-aligning the biopolymer molecules in solution to produce a biopolymeric substrate with tunable properties.

In some embodiments, the present invention also features an additive manufacturing method to produce a tunable biopolymeric material. The method may comprise: a) dissolving a biopolymer in a solvent to make a biopolymer solution comprising biopolymer molecules; b) pre-aligning the biopolymer molecules in solution; c) depositing the biopolymer solution; and d) evaporating the solvent to solidify the biopolymer solution thereby forming the biopolymeric material with tunable properties. In some embodiments, one or more conditions used for the pre-alignment, deposition, or solidification steps are used to tune properties of the final material. Non-limiting examples of the biopolymer include chitin, chitosan, keratin, alginate, or agarose.

In other embodiments, the present invention features an additive manufacturing method to produce a tunable polymeric material. The method may comprise: a) dissolving a polymer in a solvent to make a polymer solution comprising polymer molecules; b) pre-aligning the polymer molecules in solution; c) depositing the polymer solution; and d) solidifying the polymer solution thereby forming the polymeric material with tunable properties. In some embodiments, one or more conditions used for the pre-alignment, deposition, or solidification steps are used to tune properties of the final material. In other embodiments, the polymer may be a biopolymer, a synthetic polymer, or a combination thereof. In some embodiments, solidification of the polymer is achieved by evaporation of the solvent or by depositing the polymer solution into a vessel containing a counter solvent or a supersaturated gas.

In further embodiments, the final material, e.g., the biopolymeric material or the polymeric material, may undergo additional modifications. Examples of the additional modifications include, but are not limited to, dehydrating the final material, carbonization, adsorption, binding molecules to the final material, or performing solvent exchange. The additional modification step may occur before or during the deposition step, or after solidification.

In some embodiments, the final material, e.g., the biopolymeric material or the polymeric material, can be formed into a template or scaffold. Architectural features of the scaffold are used to control nucleation, growth and organization (i.e., alignment) of inorganic nanoparticles during carbonization. In other embodiments, architectural features of the scaffold are used to control material graphitization during carbonization. In further embodiments, controlled geometry of a scaffold architecture is used to control diffusion of precursors, for both graphite and nanoparticle formation, in a scaffold during carbonization (i.e., controlling the amount and distribution of polymer amorphous and crystalline regions, or the distribution of inorganic precursors). This control over the precursor behavior (i.e., migration, coalescence, nucleation, growth, alignment, etc.) during carbonization is due to architectural arrangements of the scaffold (i.e., fibril alignment, porosity, distribution of binding sites, crystallinity, etc.). In other embodiments, carbonization of aligned scaffolds results in more mechanically stable carbon materials.

In some embodiments, the properties of the final material may be tuned using one or more conditions throughout the additive manufacturing method. Examples of the tunable properties include, but are not limited to, shape or morphology, fibril alignment (e.g., affects tensile strength), surface rugosity (or patterning), density, porosity, exposed surface, crystallinity solvent content (e.g., swelling or water content), mechanical toughness, flexural stiffness, wear resistance, thermal resistance or conductance, electrical resistance or conductance, light attenuation or conduction.

Without wishing to be bound to a particular theory or mechanism, the chemical or physical properties of the biopolymer or the polymer may affect the properties of the final material. Non-limiting examples of chemical and physical properties of the polymer include molecular weight, molecular weight distribution, molecular branching, crystallite dimension, polymorphism, crystallinity, degree of substitution (i.e., degree of acetylation/deacetylation), or polarity of the molecules. Furthermore, the polymer backbone and its alignment may control the mechanical, electrical, thermal, and optical properties. In addition, if the final materials are used in membranes in water purification, catalysts in fuel cells/battery materials, or other applications, the polymer backbone and its alignment may affect the diffusion rates of analytes, ions, molecules, all of which may affect the performance of the aforementioned applications.

Without wishing to be bound to a particular theory or mechanism, the properties of the solution may affect the properties of the final material. Examples of solution properties include, but are not limited to, solution viscosity (from about 0.001 mPa to 100 MPa), the concentration of the polymer in solution (from about 0.001 to 90 wt %), and solvent choice (e.g., polarity, ionic strength, pH, presence of molecules altering polymer-polymer interactions as hydrogen bonds, etc.).

Without wishing to be bound to a particular theory or mechanism, the geometry or mechanics of the additive manufacturing process may also affect the properties of the final material. Non-limiting examples of the geometry or mechanics include a geometry of the nozzle used in the method (i.e., the shape of the nozzle: conical or cylindrical; length of the nozzle: from about 0.001 mm to about 1 m), geometry of the extrusion hole of the nozzle (i.e., circular, parallelepipedal, ovoidal) and its dimension (i.e., from about 0.01 to about 5 mm); pressure (i.e., from about 0.01 kPa to about 1000 MPa); rate of extrusion; patterning on the inside of the nozzle and the extruding hole (i.e., to insert a rugosity, pattern or asperities of any kind); or the motion of the nozzle (i.e., a vibrating or spinning nozzle). As used herein, a “nozzle” may refer to a projecting pipe or spout from which the solution or material is discharged. The methods described herein are not limited to using nozzles to deposit the solution. Any opening with any shape may be used to deposit the solution. As a non-limiting example, a core-shell tube/nozzle may be used to print two materials into one fiber.

In some embodiments, the biopolymer or polymer solution is deposited using 3D printing, extrusion, electrospinning, spin-coating, casting, or dip coating. The solution may be cast as a thin film or a substrate may be dipped into the solution to form a conformal coating. In further embodiments, the solvent may be evaporated using heat or pressure, or a combination thereof. In other embodiments, the solvent is an organic solvent, an aqueous solvent, or a combination thereof. In further embodiments, the solution may comprise additional components. Examples of the additional components include, but are not limited to, another polymer or biopolymer, biomacromolecules, bio-polymer binding molecules, inorganic or organic precursors/clusters/nanoparticles/nanofibers/nanotubules, thin sheets/films, or a combination thereof.

In some embodiments, the biopolymer or synthetic polymer may be mixed with metal salts to allow metal ions to be dispersed throughout the polymer. This may be the foundation for forming other nanostructures after printing. In addition, metal or metal oxide/nitride/carbide/sulfide/phosphide/etc. nanoparticles can be added (as opposed to metal ions). In other embodiments, proteins/peptides can be added to the polymer solution before printing. The present invention is not limited to the aforementioned examples of additives.

In other embodiments, the biopolymer binding molecules are used as a carrier of functionalization to obtain functional biopolymer based materials. In some embodiments, the biopolymer binding molecules tune mechanical properties of a polymeric scaffold (i.e., introducing cross-linking). In yet another embodiment, the biopolymer binding molecules control assembly and organization of a biopolymer by driving specific protein-protein or protein-polymer interactions. In further embodiments, architectural features in a biopolymeric scaffold are used to control binding, assembly and orientation of biopolymer binding molecules onto it. In some embodiments, the biopolymer binding molecules are functionalized. In further embodiments, the functionalized biopolymer binding molecules, both organized in a specific pattern or not, control the formation (i.e., nucleation, growth, crystallinity, orientation, polymorphism) of a mineral phase on a biopolymer-based scaffold. In other embodiments, the functionalized biopolymer binding molecules, both organized in a specific pattern or not, control the formation or binding of nanoparticles (i.e., shape, size, phase, or crystallinity) on a biopolymer based scaffold by controlling a 3D position of particle- or ion-binding functionalities.

In some embodiments, the methods described herein may further comprise modifying the final material to form metallic, ceramic, polymer, biological materials, or hybrid materials. In some embodiments, the final material is used as a template or scaffold upon which metal-based precursors can be deposited and then treated to convert them to metals, metal oxides, metal carbides, or metal nitrides.

According to other embodiments, the present invention features a system for producing a biopolymeric material. The system may comprise a biopolymer solution prepared by dissolving a biopolymer in a solvent, a first vessel configured to contain the biopolymer solution, a nozzle fluidically coupled to the first vessel, a dispenser coupled to the nozzle, a controller operatively coupled to the dispenser, the controller comprising a processor and a memory storing computer-readable instructions that, when executed by the processor, causes the dispenser to deposit the biopolymer solution through the nozzle at a desired flow rate and fiber length, and a second vessel disposed below the nozzle for collecting the biopolymer solution after the biopolymer solution is deposited from nozzle. One or more conditions from pre-alignment, deposition, or solidification in the system are used to tune properties of the biopolymeric material.

In some embodiments, the biopolymer solution comprises biopolymer molecules. In preferred embodiments, the nozzle is configured to pre-align the biopolymer molecules as the biopolymer solution is passed through the nozzle. In some embodiments, the nozzle is a cylindrical nozzle, a conical nozzle, or a core-shell nozzle. In some embodiments, the dispenser is a syringe. In other embodiments, the dispenser includes a motor coupled to the controller.

In one embodiment, the second vessel is configured to contain a counter solvent or a supersaturated gas for solidifying the dispensed biopolymer solution to produce the biopolymeric material. In another embodiment, the second vessel is configured for evaporation of the solvent so as to solidify the dispensed biopolymer solution to produce the biopolymeric material.

According to other embodiments, the present invention features a biopolymeric material prepared by a method comprising dissolving a biopolymer in a solvent to make a biopolymer solution comprising biopolymer molecules, depositing the biopolymer solution such that the biopolymer molecules are pre-aligned, and solidifying the biopolymer solution, thereby forming the biopolymeric material with tunable properties. In preferred embodiments, the biopolymeric material is formed into a template or scaffold. In some preferred embodiments, biopolymeric material is utilized for energy conversion or storage devices, implantable biomedical materials, structural materials or composites, textiles, or separation membranes.

In alternative embodiments, the system described herein may also be used for producing the polymeric materials described herein. Instead of the biopolymer solution, the system may comprise a polymer solution prepared by dissolving a polymer precursor in a solvent. In some embodiments, the polymer solution comprises polymer molecules.

According to other embodiments, the present invention features a polymeric material prepared by a method comprising dissolving a polymer precursor in a solvent to make a polymer solution comprising polymer molecules, depositing the polymer solution such that the polymer molecules are pre-aligned, and solidifying the polymer solution, thereby forming the polymeric material with tunable properties. In preferred embodiments, the polymeric material is formed into a template or scaffold. In some preferred embodiments, polymeric material is utilized for energy conversion or storage devices, implantable biomedical materials, structural materials or composites, textiles, or separation membranes.

According to some embodiments, the present invention features an additive manufacturing method comprising dissolving an inorganic polymer or inorganic material in a solvent to make a solution comprising inorganic molecules, depositing the solution such that the inorganic molecules are pre-aligning, and solidifying the solution, thereby forming an inorganic polymeric material or inorganic material with tunable properties. In preferred embodiments, one or more conditions from pre-alignment, deposition, or solidification are used to tune properties of the polymeric material. In some embodiments, solidifying the solution may comprise evaporating the solvent or depositing the solution into a vessel containing a counter solvent.

In other embodiments, the method may further comprise modifying the inorganic polymeric material or inorganic material to form metallic, ceramic, biological materials, or hybrid materials. In some embodiments, the inorganic polymeric material or inorganic material can be used as a template or scaffold upon which metal-based precursors can be deposited and then treated to convert them to metals, metal oxides, metal carbides, or metal nitrides. In other embodiments, the inorganic polymeric material is used to direct ink write high molecular weight inorganic polymers that can be aligned and then converted to metals, metal oxides, metal carbides, or metal nitrides.

According to other embodiments, the present invention features a system for producing an inorganic material. The system may comprise a precursor solution prepared by dissolving an inorganic precursor in a solvent, a first vessel configured to contain the precursor solution, a nozzle fluidically coupled to the first vessel, a dispenser coupled to the nozzle, a controller operatively coupled to the dispenser, the controller comprising a processor and a memory storing computer-readable instructions that, when executed by the processor, causes the dispenser to deposit the precursor solution through the nozzle at a desired flow rate and fiber length, and a second vessel disposed below the nozzle for collecting the precursor solution after the precursor solution is deposited from nozzle. One or more conditions from pre-alignment, deposition, or solidification in the system are used to tune properties of the inorganic material.

In some embodiments, the precursor solution comprises inorganic molecules. In preferred embodiments, the nozzle is configured to pre-align the inorganic molecules as the precursor solution is passed through the nozzle. In some embodiments, the nozzle is a cylindrical nozzle, a conical nozzle, or a core-shell nozzle. In some embodiments, the dispenser is a syringe. In other embodiments, the dispenser includes a motor coupled to the controller. In one embodiment, the second vessel is configured to contain a counter solvent or a supersaturated gas for solidifying the dispensed precursor solution to produce the inorganic material. In another embodiment, the second vessel is configured for evaporation of the solvent so as to solidify the dispensed precursor solution to produce the inorganic material.

According to some other embodiments, the present invention features an inorganic material prepared by a method comprising dissolving a inorganic precursor in a solvent to make a solution comprising inorganic molecules, depositing the solution such that the inorganic molecules are pre-aligned, and solidifying the solution, thereby forming the inorganic material with tunable properties. In some embodiments, the inorganic material is an inorganic polymer. In some embodiments, the inorganic material can be formed into a template or scaffold. In preferred embodiments, the inorganic material is utilized for energy conversion or storage devices, implantable biomedical materials, structural materials or composites, textiles, or separation membranes.

Referring to FIG. 1, the following method describes a non-limiting example of the present invention. It is to be understood that said example is not intended to limit the present invention in any way. Equivalents or substitutes are within the scope of the present invention.

### Step One

A biopolymer solution, dispersion, or slurry can be achieved by dispersing it in pure organic solvents (e.g., hexafluoro-2-isopropanol), saline solution in organic solvents (e.g., dimethylacetamide and LiCl), or aqueous solvents (by modifying the ionic strength, pH of the solution, introducing hydrogen bond disrupting molecules or surfactants, or a combination thereof, i.e., acetic acid 2 vol %, CaCl₂ solution, or urea). Nanocrystallites, nano-fibers, or polymer solution might be applied in the process. The material can be used as pure or mixed with additional components, such as other polymers, biomacromolecules (i.e., enzymes or structural proteins), biopolymer-binding molecules (i.e., chitin-binding proteins), or inorganic precursors/clusters/nanoparticles.

### Step Two

This additive manufacturing of the biopolymer can be performed using diverse techniques to pre-align the molecules in solution before inducing solidification (i.e., 3D printing, extrusion, or electrospinning). A schematic of the pre-alignment of the fibril along the deposition process can be found in FIG. 2.

Different parameters can be controlled to tune the architecture of the deposited material such as: the chemistry of the polymer (i.e., molecular weight, crystallite dimension, polymorphism, crystallinity, degree of acetylation/deacetylation, molecule polarity), the solution (concentration, from 0.001 to 90 wt. %; viscosity, from 0.001 mPa to 100 MPa), or the geometry or mechanics of the process (shape of the nozzle, such as conical, cylindrical or polygonal; length of the nozzle, from 1 to 1000 mm; nozzle inner/internal diameter (NID), from 0.001 to 5 mm; geometry of the extrusion hole of the nozzle, circular, parallelepipedal, ovoidal, etc.; pressure, from 0.01 kPa to 1000 MPa; patterning of the internal surface, inserting a rugosity, pattern, or asperities of any kind in the internal wall of the nozzle or on the edge of the extruding hole). A motion might be added to the nozzle itself to induce directionality to the shear stress applied (e.g., the nozzle might be spinning or vibrating).

In some embodiments, the solidification of the material might occur by either elimination of the solvent at different temperatures (−200 to 1000° C.) or environment pressure (10⁻²⁰ to 50 atm). In this case, the temperature might be modified either in the nozzle or on the stage where the deposition of the pre-aligned material occurs. Applying this solidification process, a thin deposition of the polymer is obtained.

In other embodiments, another approach might be the injection of the pre-aligned polymer in a counter solvent that might induce polymer solidification (i.e., water) or a mixture of a good solvent with a counter solvent (i.e., hexafluoro-2-isopropanol and water). This time a highly hydrated material is deposited as a gel.

Controlling the previously described parameters, it is possible to tune different architectural features of the final material such as shape, fibril alignment, surface rugosity (or patterning), density, exposed surface (i.e., porosity), etc. The porosity might be controlled at the micro- or nanoscale. The first one by controlling the solution parameters to stabilize gas bubbles (i.e., air, nitrogen, argon, etc.) of different dimensions and concentrations. The second by controlling the density of the final material and the alignment of the polymer.

The gel material obtained shows a low density and a high fibrillar alignment. Due to the solidification of the polymer close to the walls of the nozzle, the material surface may show a wrinkled appearance at microscopic level (probably due to a slip-step effect). Along with the previously described architectural features, density and surface morphology can also be controlled by customizing the parameters mentioned. By controlling the condition of solidification (for example, decreasing the percentage of the counter solvent or introducing a gradient in it), and thus the velocity of the solidification process, it might be possible to control the difference in density between the surface and the bulk of the gel within fibers.

All of these architectural features have a strong influence on the final mechanical properties and interfacial interactions/reactions of the material. As an example, by customizing the fibril alignment and the external wrinkles of the surface, it might be possible to independently control the mechanical resistance (due to fibril alignment) and elasticity (due to surface deformability) of the material itself.

### Step Three

Once the material is deposited in the gel state, it might either be applied in its wet or dry state. The dry state might be induced by simple solvent elimination (using different temperature and pressure settings, from −200 to 1000° C. and from 10⁻²⁰ to 50 atm), by freeze drying, or critical point drying (prior eventual solvent exchange, i.e., ethanol, methanol, or acetone).

The material obtained (either hydrated or not), if deposited without any specific geometrical orientation, might also be applied as a wire or to make wires and, potentially, be used to sew tissues to further customize the mechanical behavior and exposed surface of the final system.

The obtained material could also be functionalized to change its chemical structure for functional purposes (i.e., metal chelation), or being further manufactured (i.e., being treated with binding molecules or being carbonized). More than one of these manufacturing processes might be applied to reach the final material (i.e., the material might be treated with binding molecules that exhibit chelating groups, then treated with inorganic precursors, and carbonized).

Interaction with Biopolymer-Interacting Molecules

All of the final materials obtained from this process can be applied as a platform to interact with binding molecules (e.g., proteins, dyes, peptides, or peptide analogs), functional derivatives of them, or new molecules bioinspired from the previous ones described. The specific architecture (e.g., fibril alignment) of the polymer can be used to template a specific pattern of the binding molecules. The interaction with these molecules might occur before the material deposition (using a solution of polymer and binding molecules), during the deposition (by inserting the molecules in the counter solvent), or post deposition (immersing fibers after processing, or generally by exposing the deposited material to the molecules successively). These binding molecules might introduce new properties in the material or help tune its pre-existing properties (i.e., mechanical properties), be used to drive specific interactions on the polymers (i.e., introduce a new level of organization or cross-linking), or introduce some additional functionality such as biocatalysis. Depending on the functionalities exposed by the binding molecules, this scaffold can find applications in medicine, catalysis, water purification, etc. The functionalities might also be used to control the deposition of a secondary material, such as being used as a nucleating point for nanoparticles or a mineral phase. In this case, the design of the matrix architecture might help in controlling further parameters, such as shape, size, phase, or crystallinity, by controlling the 3D position of the functionalities. This new final material might find applications in energy storage, electronics, sensor engineering, etc.

### Carbonization

The material obtained might also be mixed with inorganic precursors. These precursors might be based on transition metals, lanthanoids or actinoids, Al, Sn, or Ca and can either be ions, clusters, or particles. The metal ions might be present in either the initial solution, in the solution where the printed material is injected, or being later absorbed on the deposited scaffold. Eventually, the precursor might change state or chemical composition along with the manufacturing process too (i.e., using metal alkoxides which precipitate when in contact with water, that might be the counter solvent). It is already known in literature how the carbonization of polymers (i.e., chitin) mixed with transition metal ions can lead to a final material with metal nanoparticles having a shell of graphite; a general higher degree of graphitization was observed too. The carbonization process might occur in different atmospheres (nitrogen, argon, hydrogen, oxygen, air, or any other 0-100% mixture of the mentioned gases). It might be performed at different temperatures (from 200 to 2000° C.) and for different times (from 0.1 to 72 h). A temperature ramp might be used to increase the temperature before the carbonization or to decrease it after. A multi-temperature step treatment (with or without different atmospheres) at lower temperatures might be applied to stabilize the matrix before the carbonization (even though it appears not to be necessary for chitin for example).

During carbonization, the metal ions migrate in the sample to coalesce into nanoparticles. Concurrently, the metals can be used to catalyze the formation of graphite in the scaffold. As a general idea, the controlled geometry of a scaffold architecture may be able to control the diffusion of the precursor in the scaffold during the carbonization process. During this process, the less organized (or amorphous) area of the scaffold should degrade faster and might provide the nutrients for growth of the graphite scaffold. Meanwhile, more crystalline/aligned areas might be able to control the final arrangement of the particles. The final result would be a scaffold with local alignments of the nanoparticles and, by controlling the migration of the metal ions, a better control over their shape and dimension. Moreover, the carbonization of an aligned scaffold can result in a more mechanically stable material. This control over the precursor behavior (i.e., migration, coalescence, nucleation, growth, alignment, etc.) during carbonization thanks to architectural arrangements of a polymeric scaffold (i.e., fibril alignment, porosity, distribution of binding sites, crystallinity, etc.) can be extended not only to the manufactured scaffold discussed, but also to general polymeric scaffold with controlled architectures (i.e., synthesized using magnetic field alignment).

All of the final customized materials obtained can find a wide range of applications depending on the customization. In non-limiting embodiments, these final materials can find applications in energy storage, water purification, catalysis/photocatalysis, or sensor engineering. In most of the mentioned fields, a high exposed surface is required along with the possibility to customize the mechanical properties of the material. The manufacturing of these green materials, especially in a low dense gel state, allow the production of materials with a tunable porosity (from the nano- to the microlevel) and exposed surface, while also controlling architectural features responsible for its mechanical properties.

### Example

The following is a non-limiting example of the present invention. It is to be understood that said example is not intended to limit the present invention in any way. Equivalents or substitutes are within the scope of the present invention.

The experiment described herein demonstrates a novel one-step multivariable additive manufacturing process for polymeric gel fiber production with control over its micro- and nano-architectural features. Chitin was tested as the polymer and water as a counter solvent, in order to obtain a green and biocompatible final scaffold. A single variable, the NID, was studied to evaluate its influence on the final material properties. The screening of the NID influence on the scaffold production showed how a single variable is able to influence many different architectural features. In fact, a positive correlation between NID, fibril alignment, and mechanical resistance was observed, likely correlated to the shear stress produced in the nozzle. A negative correlation, still related to the degree of fibril alignment, was observed with porosity, exposed surface, and lightly with water content. No correlation was observed with maximum elongation, and biocompatibility, which appeared always unaltered. Overall, a single variable allowed for customization of many different material features, which could be further tuned adding control over other aspects of the synthetic process. This would reflect in the production of diversified materials which could find use in many different fields, including biomedical applications.

### Materials and Methods

### Chitin Gel Fibers Preparation

A 1 wt/vol % chitin solution (5-10 mL) was prepared using α-chitin from crab shell dissolved in 1,1,1,3,3,3-hexafluoro-2-isopropanol (HFIP) in a glass vial and stirred over-night. Both reagents were purchased from Sigma Aldrich. The same batch of chitin was used during the whole data collection.

The chitin solution was loaded in a syringe and was allowed to rest for 10 minutes to eliminate trapped air bubbles. A steel nozzle was then mounted on the end of the syringe and the system was placed in a BIO X, CELLINK 3D printer. The tip of the nozzle was suspended in a 50 mL plastic vial filled with distilled water, with the nozzle tip immersed within the water. Different gauge cylindrical steel nozzles were tested: 20 G (0.81 mm nozzle internal diameter (NID)), 22 G (NID 0.64 mm), 25 G (NID 0.455 mm) and 27 G (NID 0.361 mm), while only one plastic conical nozzle was tested, 22 G (NID 0.41 mm). All nozzles were purchased from CELLINK. The solution was then extruded using a controlled pressure of 75 kPa to obtain a continuous gel fiber with desired length. After printing, the gel fiber was left in DI water overnight to equilibrate and allow the organic solvent to diffuse out of the fiber prior to usage. The samples used for biocompatibility tests were prepared by extruding the solution into sterile water and using a plastic vial sterilized with 70 vol % ethanol.

### Wet Diameter and Water Content Measurement

The fiber's wet diameter was measured by laying a fiber on a glass slide, eventually eliminating the excess of water by blotting with a tissue. At least 6 different locations were imaged along a >3 cm long fiber. The images were collected using an AmScope SM-2T optical microscope equipped with an AmScope MU500 camera at 4.5× magnification. Image analyses were performed using ImageJ. The error of the measurement was determined as the standard deviation on the >6 measurements performed.

The water content of the gel fibers was measured by weighing a wet fiber that was lightly blotted on a tissue. The fiber was subsequently left overnight at room temperature in a desiccator under vacuum and then re-weighed. Each sample measurement was repeated at least two times on independent samples. A Quintix35-1S, Sartorius balance was used to determine the fiber weight. The water content was calculated as: water %=(wet wt./dry wt.)×100. The error of the measurements was determined as the standard deviation on the results of 2 or 3 independent samples.

### SEM and Optical Microscope Imaging

Optical micrographs were collected on wet samples laid on glass slides, eventually eliminating the excess of water with a tissue. The images were acquired using an Am-Scope SM-2T optical microscope equipped with an AmScope MU500 camera and using 4.5× magnification.

Each specimen was dehydrated prior to conducting scanning electron microscopy (SEM) imaging using an ethanol gradient (from 0 vol. % to 90 vol. %, in 10 vol. % increments of 1 h at 4° C., then 95 vol. %, 100 vol. % and 100 vol. % for 1 h at 4° C.). Finally, the remaining ethanol was eliminated by critical point drying using CO₂. The specimen was mounted on carbon tape attached to an aluminum stub. The specimen was handled with care, by picking up only one of the ends of the fiber and laid across the carbon tape, in order to avoid mechanical damage from the forceps. Each sample was coated with 5 nm of Ir prior to imaging and imaged using a FEI Magellan 400 XHR SEM at 3 kV and 13 pA.

### Image Analyses

Collected SEM micrographs were analyzed using OrientationJ, a plugin of ImageJ. For each specimen, four different parameters were calculated in duplicate (on two independent SEM samples) using images acquired at 25 000× magnification. Micrographs imaged at 50 000× were used if there was more than one preferential direction or if too flat of a distribution was observed. The fibril-fiber coherence was determined as the absolute value of the difference between the angular direction of the fiber (image at 350×) and the calculated angular direction of fibril distribution. The distribution of orientation represents the difference of distribution between the maximum and its orthogonal direction. The full width at half maximum was calculated by normalizing the distribution to zero. Finally, the percentage of coherency was calculated for the dominant direction. The error associated with each result was calculated as a standard deviation of the analyses of the two images analyzed, for each sample.

### Uniaxial Tensile Tests

Uniaxial tensile tests were performed using a Bose Electroforce 3200 Dynamic Mechanical Tester equipped with a 50 g loadcell manufactured by Honeywell. A wet fiber was mounted on a plastic frame (with a ˜1.8 cm window) using superglue to fix the fiber's edge to the frame, and sodium bicarbonate was used as an accelerant to achieve glue curing in a few seconds. The actual length of the fiber was measured with a caliper (t 0.01 mm). The frame was mounted on the instrument, then the sides of the frame were cut to release the fiber for testing. The tests were conducted using a strain rate of 0.05 mm·sec⁻¹ for all samples. A humidifier was used to keep it fully hydrated before and during testing. The average wet diameter previously measured was used to calculate the stress. The Young's modulus was measured as linear interpolation of the strain range between 5% and 30%. At least 6 independent samples were tested for each condition; the error associated with the result was obtained as a standard deviation.

### Biocompatibility Tests

Cytotoxicity assay of the chitin gel fibers was performed using a Cell Counting Kit-8 (CCK-8), which allows sensitive colorimetric assay for the cell viability. MCF-7 human breast cancer cells (ATCC, Virginia, USA), which are the most studied human adherent cells, were cultured in Eagle's minimal essential medium (MP Bio, Santa Ana, CA, USA) supplemented with 1 mM sodium pyruvate, 10 μg/ml insulin, 1.5 mg/ml sodium bicarbonate, 10 vol. % fetal bovine serum, and 1 vol. % penicillin-streptomycin. Cultures were maintained at 37° C. and 5% CO₂ for approximately 1 week. Prior to each experiment, confluent cell cultures were washed with phosphate-buffered saline (PBS, pH 7.4) followed by trypsinization and resuspension in PBS. The cells were seeded into 48-well at 2.5×104 cells·well-1 in a total volume of 200 μL. The gel fibers (22 G, and 27 G), cut into 1 cm pieces, were treated with boiling water for 5 min and then introduced into the wells. The cells with fiber gels were cultured at 37° C. and 5% CO₂ for 24-144 h (1-6 days). A CCK-8 solution (20 μL) was added into each well at 0, 24, 48, 72, 96, 120, and 144 hours followed by a color reaction. After incubation for 4 hours, the absorbance at 450 nm was measured. The condition of the cells around the fiber gels was observed under an inverted microscope (OLYMPUS IX71). All results were performed in triplicate.

### Results

A few tests were performed with the first method (evaporation method). These tests used a 22 G cylindrical nozzle, a pressure of 25 or 50 kPa and a 10 mm·sec⁻¹ printing speed, the material was printed on a 60° C. heated stage. Due to lack of contrast, it was not possible to observe whether fibril alignment was present in the sample using scanning electron microscopy. A couple of micron thick deposition was observed.

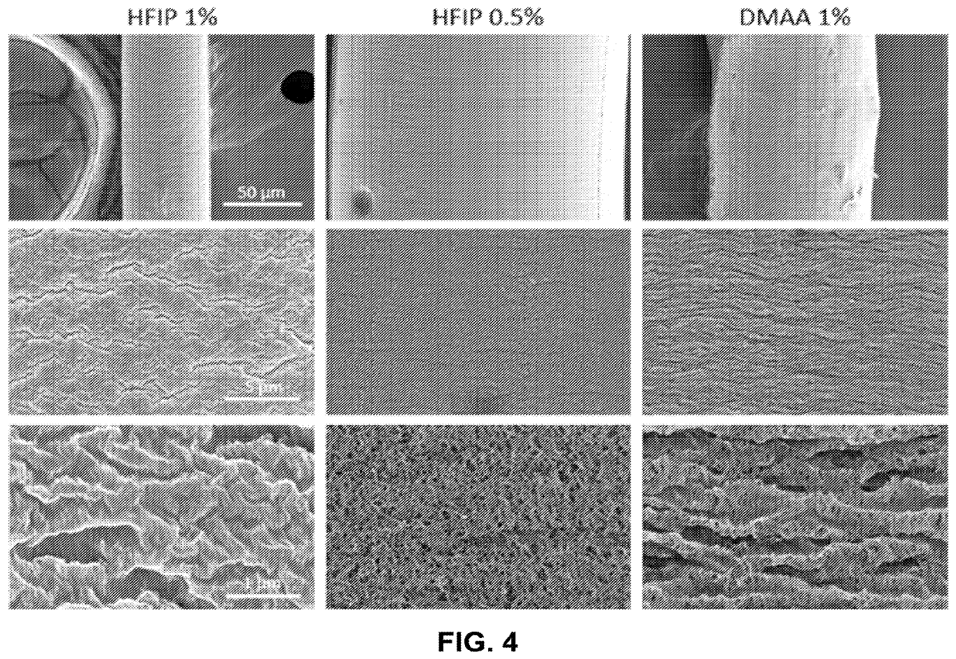

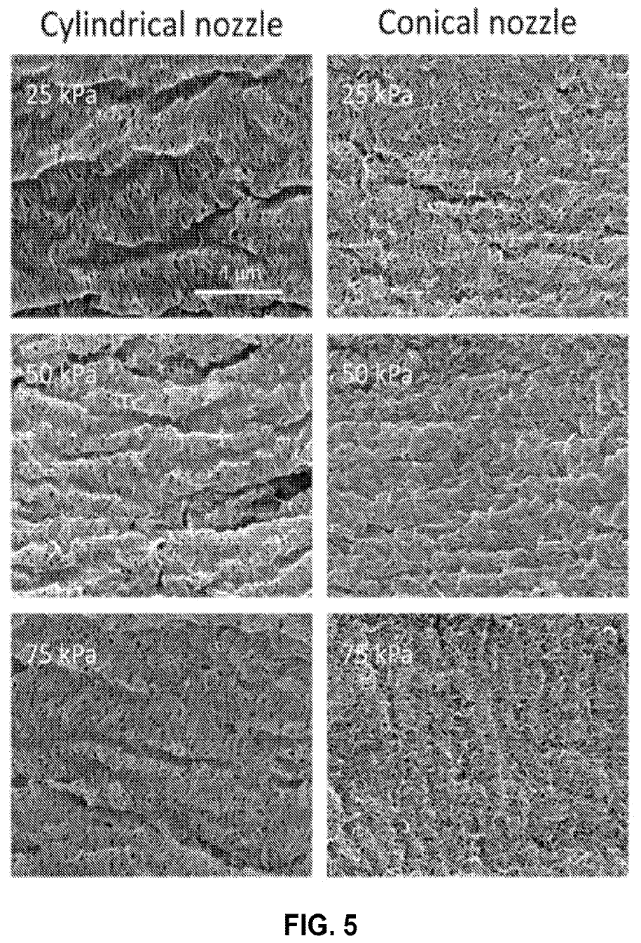

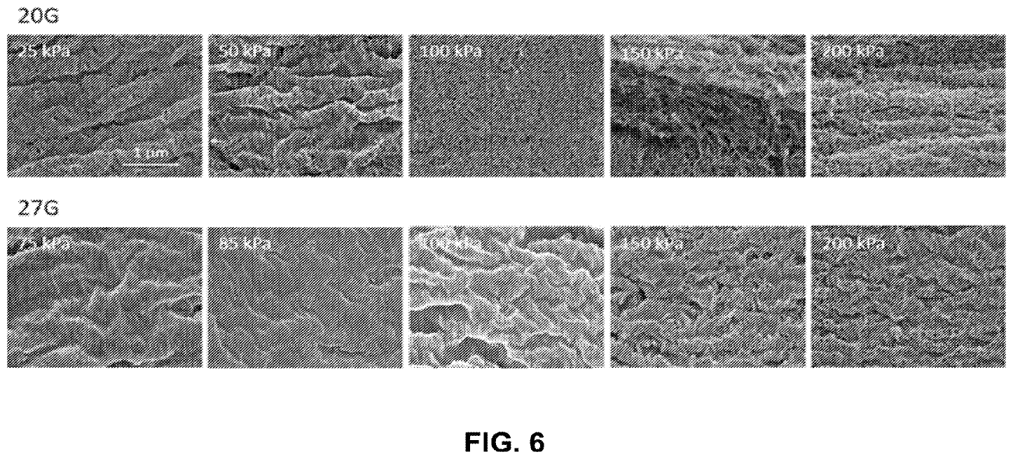

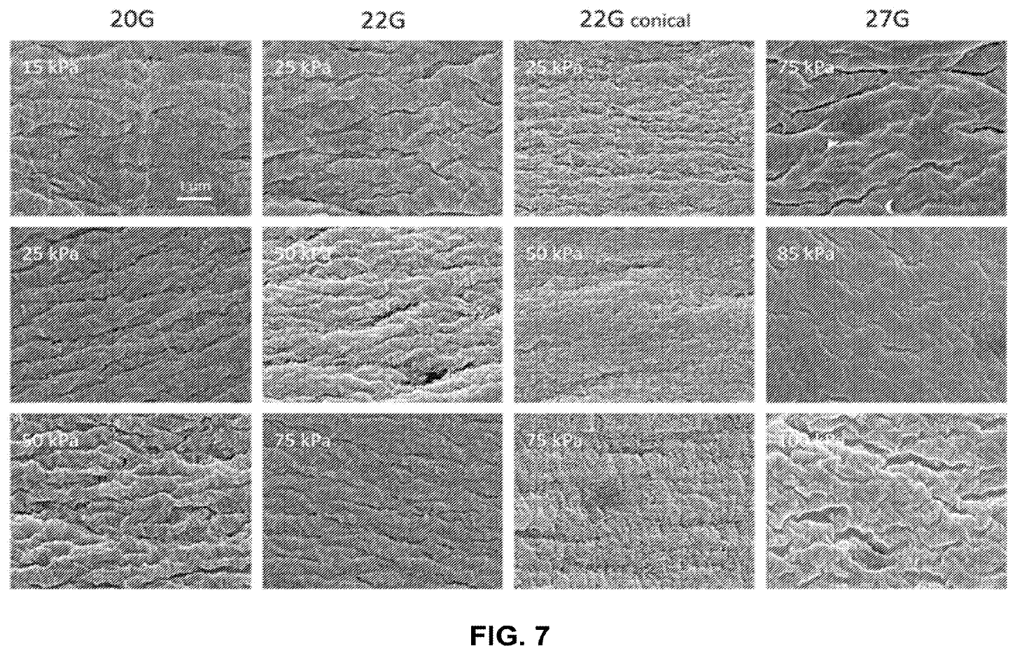

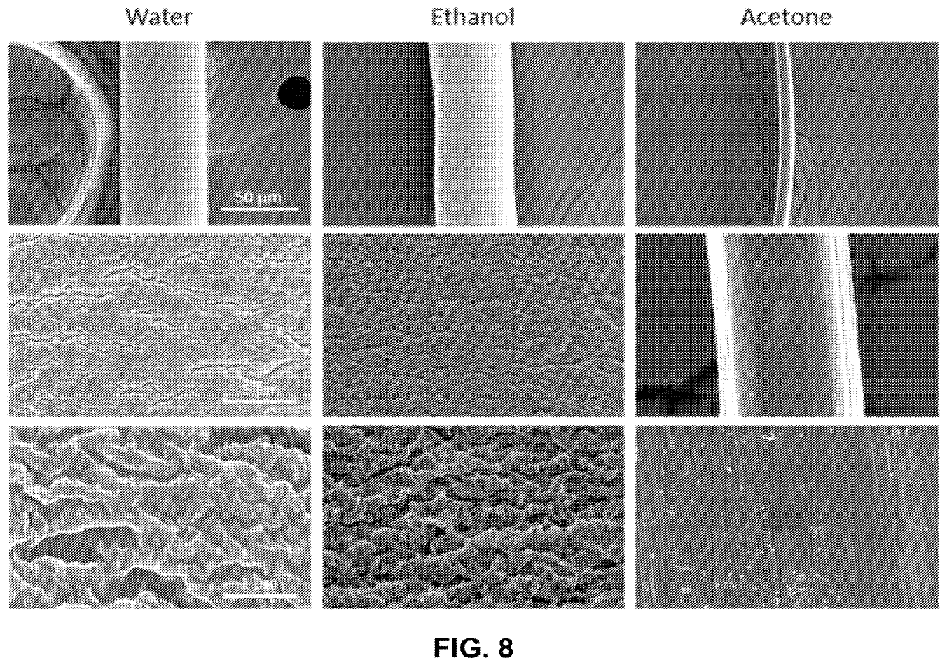

The injection of the polymer solution in a counter solvent has also been investigated. This printing process was performed with varying: i) solution parameters (FIG. 4): chitin concentration (0.5-1%), or solvent (HFIP or dimethylacetamide/LiCl 5%); ii) nozzle geometry (FIGS. 5-7): nozzle shape (conical or cylindrical), or internal diameter (20 G to 27 G); printing parameters (FIG. 6 and FIG. 8): pressure (15-200 kPa) and counter solvent (water, ethanol, or acetone).

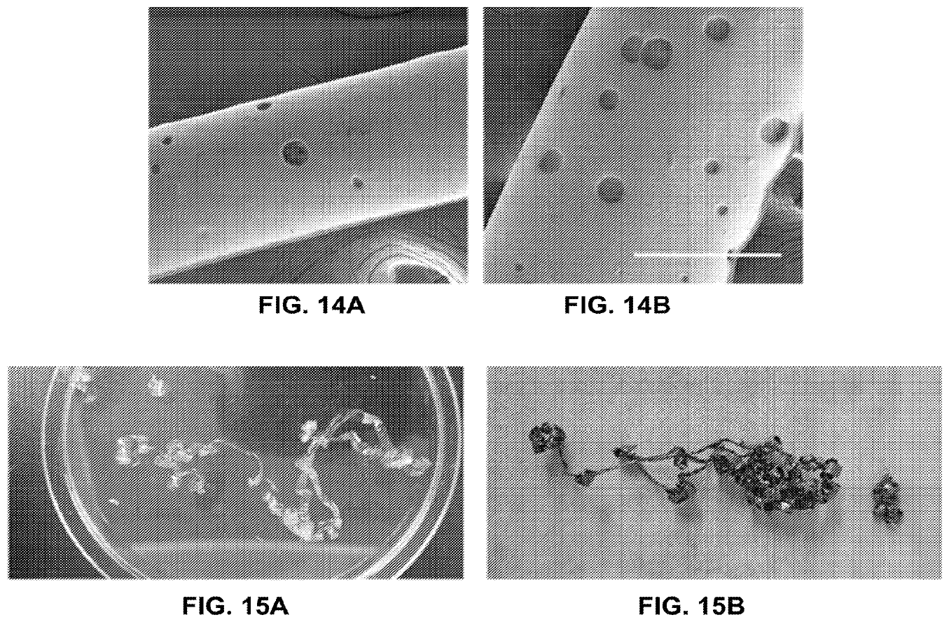

Tuning these diverse parameters during the printing process, inventors were able to control different architectural features of the final material. Such features include, but are not limited to, fibril alignment, the deposited material rugosity, or the scaffold micro- and nano-porosity. The results suggest that a thinner nozzle diameter induces a higher fibril alignment and surface wrinkles of bigger dimension. The same was observed using a cylindrical nozzle compared to a conical one. An optimal pressure range window can be identified to get higher fibril alignment (FIG. 6). The scaffold porosity can be tuned either by decreasing the chitin concentration to induce higher nano-porosity (FIG. 4), or by stabilizing air bubbles in the solution to induce higher micro-porosity (FIGS. 14A-14B). The choice of the counter solvent appears to have a strong effect on scaffold density, porosity, and fibril alignment.

Once the material was printed, it was possible to obtain a carbonized scaffold by heating it at 800° C. for 2 h in a N₂:H₂ 95:5 atmosphere with the temperature being raised using a 5° C./min ramp. Both printing methods (solvent evaporation and injection in water) gave a mechanically stable carbonized material (FIGS. 15A-15B). The carbonization of a pure chitinous scaffold showed a low degree of graphitization.

### Nano-Organized Chitin-Based Gel Fibers' Synthesis and Characterization

The chitin-based hydrogel fibers utilized in this study have been synthesized starting from a homogenous 1 wt/vol % solution of α-chitin in HFIP. The synthesis was performed via a controlled extrusion at 75 kPa of the solution into a counter solvent (FIG. 2), in this case distilled water, that induced the precipitation of the biopolymer. A screening study of the nozzle internal diameter (NID) was performed to determine its influence in the resulting fiber diameter and molecular alignment in the chitin-based hydrogel fibers. Four steel cylindrical nozzles were tested: 20 G (NID 0.81 mm), 22 G (NID 0.64 mm), 25 G (NID 0.455 mm), and 27 G (NID 0.361 mm). In addition, a 22 G plastic conical nozzle, 22 G con, (NID 0.41 mm), was tested.

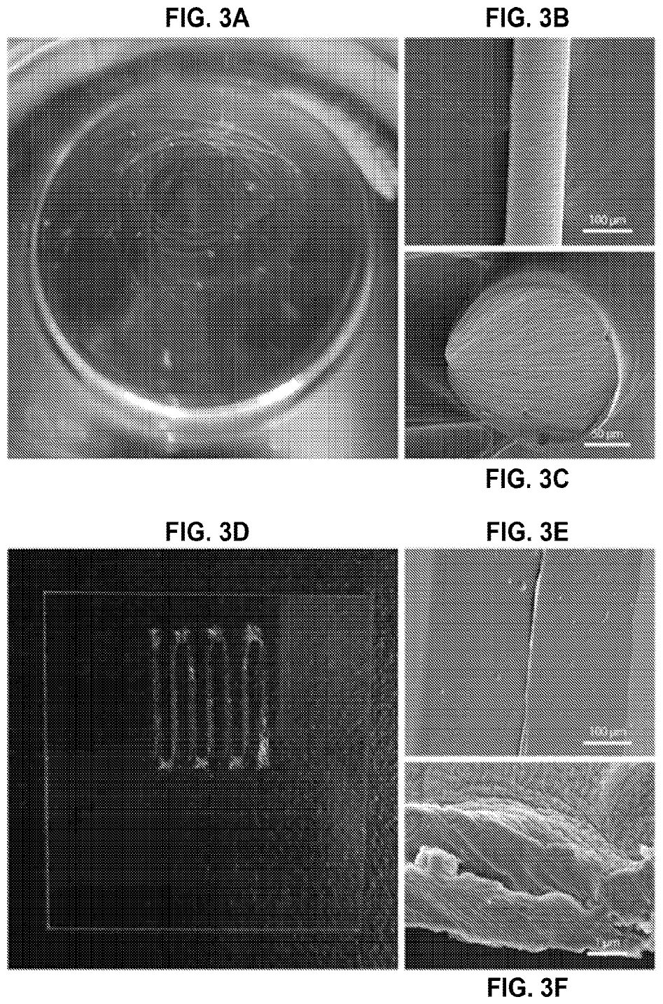

Two different printing processes were tested (FIG. 3): i) evaporation of the solvent from the deposited material (either at room temperature or heating the printer stage up to 60° C.) to obtain a thin chitin layer deposition, or ii) injection of the solution in water to induce an instant precipitation of the polymer to obtain a gel.

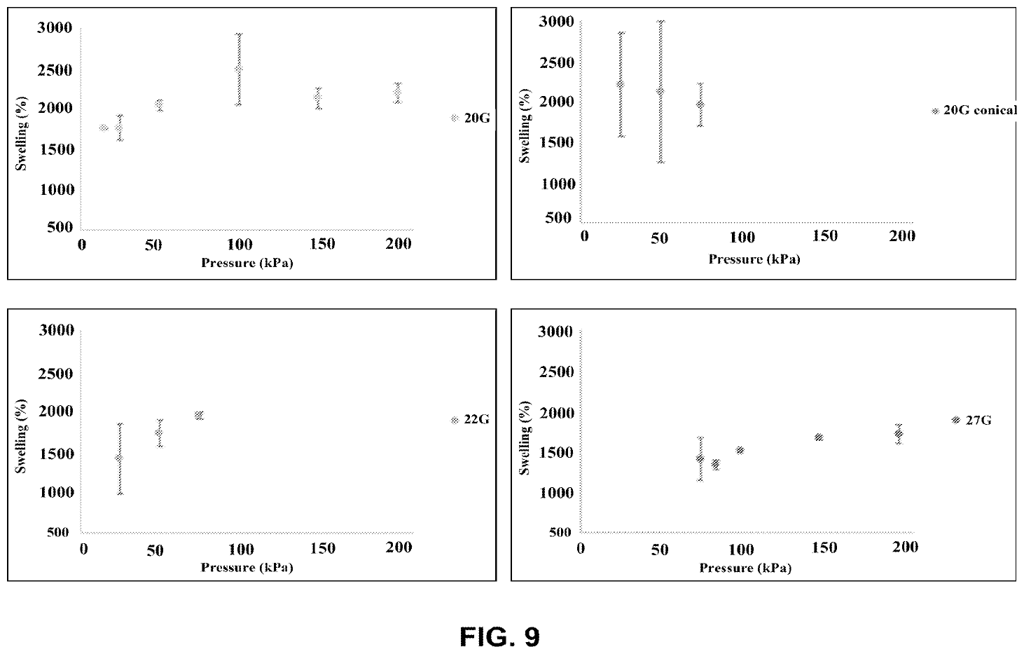

As reported in FIG. 9, the water content (swelling) of the matrices varies depending on the parameters used. A higher pressure generally induces a higher hydration. This might be due to the higher velocity of solidification that does not allow the polymer to rearrange in a more stable (and less hydrated) conformation. The internal diameter of the nozzle also has an influence on this parameter, with higher diameters producing higher swelled scaffolds. This last observation is probably due to the higher fibrillar alignment observed in thinner diameters that reduces the interaction with the solvent. This hypothesis is coherent with what was observed in changing the shape of the nozzle from cylindrical to conical.

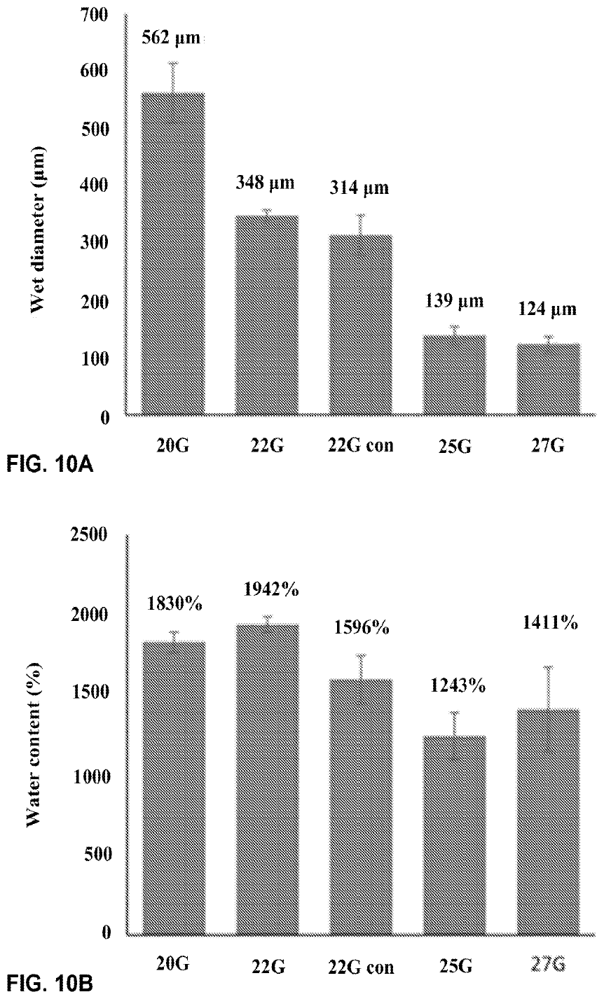

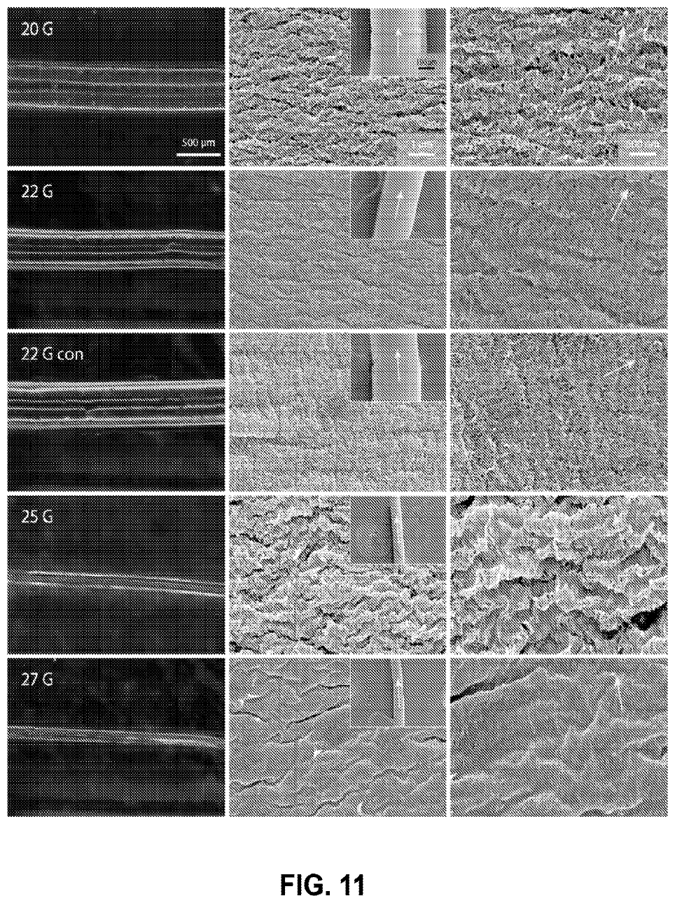

As can be observed in the optical microscopy images shown in FIG. 11, all printed chitin hydrogel fibers were transparent gel fibers, barely visible in water. The length of the fibers is controlled by the duration of the extrusion process, potentially leading to meter-long fibers. For example, scaffolds more than 0.5 m long have been easily obtained, suggesting the scalable nature of this process that is only limited by the size of the syringe and immersion tank. The wet diameters of the fibers were dependent on the nozzle used. FIG. 10A highlights the lower limits (in this experiment) of fiber diameters using nozzles with a lower NID. Comparing the fiber diameter to the NID, the cylindrical nozzles showed a contraction of the extruded material of about 250-300 μm. A contraction of about 100 μm was observed for the conical nozzle.

The water content of the different fibers, reported in FIG. 10B, was between 1200-2000 wt % (i.e., only between 8.3-5.0 wt % of the scaffold was chitin). Considering the standard deviation, the scaffolds showed comparable water contents. A general decrease trending with lower NIDs was observed, with the largest observed water content for the 22 G nozzle and the smallest for the 25 G nozzle.

The TGA analysis of the fibers confirmed that most of the fiber weight was made up by water. Generally, the lower the NID used to produce the fiber, the lower temperature was observed to be required to fully dehydrate the scaffold, except for sample “22 G con” which exhibited the highest temperature (comparable to 20 G) to fully dehydrate the matrix. An analogue trend was observed in the heat flow associated with the dehydration event where a more negative heat flow was associated with a bigger NID, while “22 G con” showed the most negative heat flow peak value.

### Micro- and Nano-Structural Analyses of the Chitin Gel Fibers

In order to evaluate the micro- and nano-structural features of the scaffold, the samples were dehydrated using an ethanol gradient and subsequently critically point dried prior to analyzing them using SEM (using a 5 nm Ir coating). As reported in FIG. 11, the analyses showed an overall homogenous fiber with semi-periodic (ca. micron scale) wrinkles, orthogonal to the primary fiber direction, on the surface. A fibrillar morphology was observed at the nanoscale level. Among the cylindrical nozzles, there is a general increase in the fibrillar alignment, longitudinal to the primary fiber direction, as a function of decreasing NID. Conversely, an increase of the interspacing of wrinkles was associated with a decrease in NID, leading to larger sized wrinkles associated with a higher fibrillar alignment and vice versa. Interestingly, almost no fibrillar alignment was observed when the conical nozzle was used and the very small wrinkles observed appeared almost parallel to the primary fiber direction. Occasional aberrations or imperfections, such as air bubbles imprinted on the surface were observed.

SEM image analyses of the different scaffolds revealed the effect the cylindrical nozzles had on the degree of fibrillar alignment within each fiber. Specifically, a higher alignment, both in terms of distribution and intensity, was observed using a smaller NID (Table 1). This trend was observed in all the parameters studied. A general fair coherence between the extrusion direction of the fiber and the fibrillar alignment was observed (fibril-fiber coherence), except for the “22 G con” nozzle. In this sample, two orientation directions: (i) approximately 90° from one another or (ii) a broad bell-shape with a flat plateau, were observed at 25 000× magnification. The alignment distribution became more unidirectional when analyzing micrographs at 50 000× magnification. This second analysis showed a poor fibril-fiber coherence compared to the cylindrical nozzles. For this reason, no FWHM and coherency were calculated on this sample. A similar flat bell-shape was observed on the 25 G samples. The distribution became more oriented using images acquired at 50 000× magnification, obtaining results analogous to the other specimens.

TABLE 1
Fibril alignment parameters obtained from SEM images (25 000×).

| | Fibril-fiber | Distribution | | |
|---|---|---|---|---|
| | coherence | of orientation | | |
| | (°) | (·10³) | FWHM (°) | Coherency (%) |
| 20G | 16 ± 1 | 5 ± 3 | 90 ± 30 | 0.03 ± 0.02 |
| 22G | 16 ± 3 | 14 ± 4 | 90 ± 30 | 0.13 ± 0.04 |
| 22G con | 60 ¹ ± 10 | 13 ¹ ± 5 | n.d. | n.d. |
| 25G | 10 ¹ ± 10 | 17 ¹ ± 7 | 60 ¹ ± 20 | 0.14 ¹ ± 0.02 |
| 27G | 7 ± 8 | 37 ± 2 | 34 ± 1 | 0.33 ± 0.03 |

¹ These data were acquired on images at 50 000 × magnification.

### Uniaxial Tensile Tests of the Wet Chitin Gel Fibers

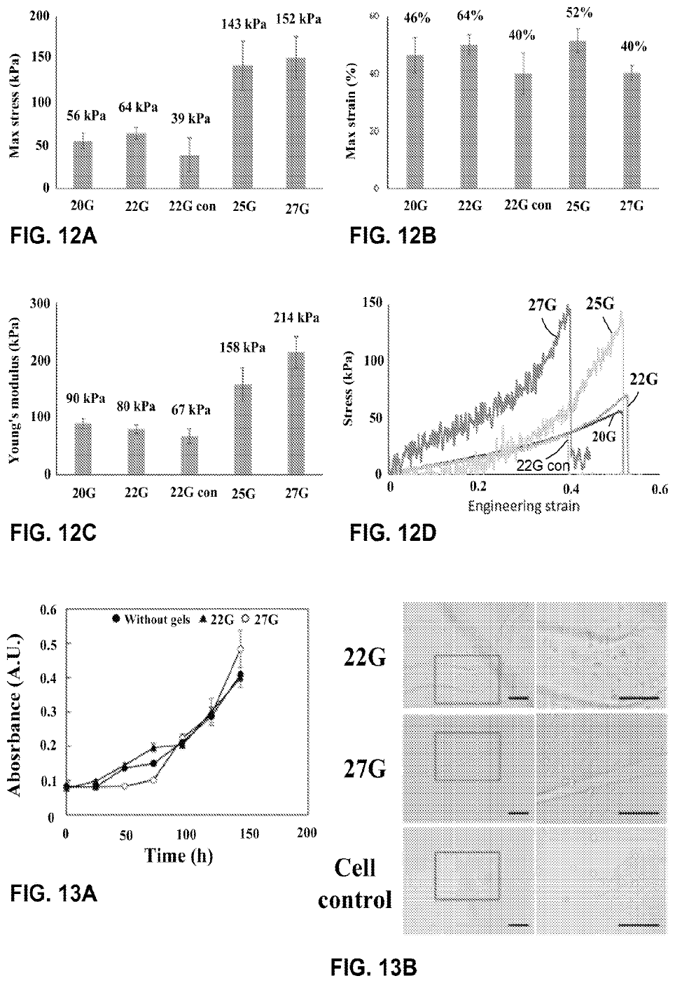

The wet samples were also tested using uniaxial tensile tests to evaluate their mechanical properties, with the results summarized in FIGS. 12A-12D. The stress-strain curves showed an analogous trend for all the samples examined. Each tensile profile showed an initial lower slope (up to about 30% the maximum elongation) that transitioned into a higher slope until fiber breakage. Each fiber broke in a single event, no defibrillation was observed. The three mechanical parameters examined were the maximum stress (σmax), maximum strain (εmax), and the Young's modulus (YM). YM was calculated on the first slope observed (between 5% to 30% strain). For each parameter, a t-test was performed on the data belonging to each data set. All samples showed no significant differences in the εmax (v≥9, p=0.05), showing a value of about 50%. A slightly lower value (40%) was observed for “20 G con” and 27 G. The σmax (v≥10, p=0.05) and YM (v≥11, p=0.05) showed no significant differences for 20 G, 22 G, and “22 G con”. A σmax value of ˜60 kPa, and a YM value of ˜80 kPa were observed. A significantly higher value was observed for 25 G (σmax˜140 kPa, and YM˜160 kPa), and 27 G (σmax˜150 kPa and YM˜200 kPa), but no significant difference between these two samples was observed. Aside from the statistical evaluation, increasing trends in both σmax and YM are observable moving from 20 G, 22 G, 25 G and 27 G.

### Scaffolds' Biocompatibility

In order to evaluate the biocompatibility of the fibers, a cell culture was performed in presence of the fibers. In this experiment, two types of scaffolds were tested: 22 G and 27 G, using the same fiber length. The gels were introduced into each well and incubated for 144 hours (6 days). FIG. 13A shows the cell viability during the culture period. Regardless of the diameter of the gels, there was no clear difference from the culture in the absence of gel. In addition, at the bottom of the well after 144 hours from the start of co-culture, it was confirmed that cells were growing around the gels with no difference in density compared to elsewhere in the well (FIG. 13B). In order to increase the cell adhesion to the scaffold, an introduction of adsorbed collagen within fibers was performed. After this treatment, cells were observed to adhere to the scaffold.

### DISCUSSION

This experiment featured methods of synthesizing transparent nano-structured biopolymeric gel fibers with customizable water content, mechanical properties, and fibrillar alignment. One of the possible variables was studied to evaluate its influence on the final scaffold architecture. The effect of NID is discussed, which was selected based on facile control and standardization, while granting a strong influence on the micro- and nanoarchitectures and final matrix properties. As an additional test, a nozzle with a conical shape, as opposed to cylindrical, was also utilized to evaluate the influence of geometry.

A screening on the influence of the NID was conducted using one conical and four cylindrical nozzles, at a constant applied pressure of 75 kPa. The starting solution used was 1 wt/vol % chitin in HFIP. This concentration was chosen as the highest concentration achievable to obtain a homogenous solution of chitin in HFIP using magnetic stirring. A high concentration was preferred since it presented a viscosity compatible with extrusion processes and, thus, the possibility to obtain a self-standing gel. The batch of chitin used was the same one in the whole study, so no modification in composition should be present. The average molecular weight of the chitin used was not available. This is quite common for chitin, contrary to chitosan, which does not undergo any harsh extraction treatment and is usually sold as a high molecular weight product (few hundreds of kDa). The concentration and molecular weight were not modified in this study, although they are expected to be crucial parameters in determining the mechanical resistance of the gel. For example, increasing the gelfying agent concentration was observed to have a positive correlation with the mechanical resistance.

The five matrices obtained from the different nozzles tested were esthetically similar, long transparent gel fibers. This suggested that the precipitation of the biopolymer in the counter solvent was fast enough to inhibit a complete disassembly of the material, and thus resulted in significant fibril alignment and water content. Similar extrusion processes were performed on biopolymers without achieving an analogue fibrillar alignment. The high hydration that biogenic and synthetic chitin matrices exhibit suggested a strong tendency of the polymer to entrap water. Despite this, shrinkage of the gel was observed overnight after printing. In fact, immediately after extrusion, the fibers had diameters comparable to the NID. However, after soaking overnight in water, a decrease of the gel diameter was observed. This change in diameter may be related to a local rearrangement/alignment of the bio-polymer fibrils in a more compact conformation (potentially due to more extensive interpolymeric hydrogen bonding, leading to higher crystallinity, or to an increase interaction between chitin's apolar regions during the exchange of water for HFIP) and/or an effect of the osmotic pressure due to, again, the exchange of water for HFIP.

It appeared that all fibers experienced a similar decrease in diameter, regardless of the nozzle diameter used. The only significant difference was observed for the 22 G conical nozzle, which demonstrated an approximately 50% of the decrease in diameter. If an osmotic pressure is responsible for this shrinkage, thicker fibers were expected to show a higher decrease in diameter. In fact, the diffusion of the two solvents would require a longer time to reach the fiber bulk. This would imply that fibers obtained from nozzles with similar NID, such as the 25 G and the 22 G conical nozzles (NID of 0.45 mm and 0.41 mm, respectively) would undergo similar diffusion processes. This would lead to similar final wet diameters, which was opposed to the evidence collected. A major difference observed in the conical nozzle is the significant absence of fibril alignment, while all cylindrical nozzles showed measurable orientation. This, combined with the observed reduction in the decrease of the fiber diameter, suggest a major factor is the localized reorganization/alignment of the fibrils. The fibrils might in fact have a higher tendency to contract when fibrillar alignment is present, likely due to extensive interpolymeric interactions. In fact, a more compact surface (i.e., closer packing of fibrils) is observed in the samples with an overall higher fibrillar alignment. This suggests a tendency of aligned fibrils to interact less with the solvent.

The rate of precipitation and the successive fibril compaction may also have an effect on the final water content of the gel. Generally, no strong differences were observed among the samples. However, a general trend showed thinner nozzles having lower water content. As for the wet diameter, higher water content was observed in the 22 G conical nozzle compared to the fiber printed with the 25 G nozzle. These observations suggest that more compact fibrils allow less water to get entrapped in the scaffold. Since a similar shrinkage of the fiber was observed, unrelated to the NID, the fibril compaction event may not be strongly involved in the decrease of the hydration. A possible explanation may be the decrease of the polymer exposed surface, now involved in fibril lateral interactions, with no more ability to interact with water. This observation was also supported from the TGA analyses. Among the cylindrical nozzles, a general correlation was observed between the NID and the temperature at which full dehydration occurs in the matrix. This may possibly be related to faster dehydration kinetics due to the smaller fiber diameter. Despite that, it was expected that more strongly bounded water would be retained in the structure up to higher temperatures (usually above 100° C.) and required more energy to be evaporated. These water molecules are in fact the ones in direct contact with the fibrils and are directly linked by hydrogen bonding. This may explain why fibers exhibiting higher fibrillar alignment required a higher temperature to fully dehydrate with more energy to evaporate water above 100° C. In fact, the two samples with the highest fibrillar alignment (25 G and 27 G) were the only ones showing full dehydration before 100° C., associated with the lowest heat flow. Coherently, the conical nozzle, which exhibited the lower fibrillar alignment but a wet diameter comparable to the 22 G nozzle, showed the highest temperature of full dehydration (comparable to that of the 20 G sample). The combination of the swelling, TGA, and wet diameter results support the idea that a lower fibrillar alignment is associated with a lower hydration, since a lower interaction with the solvent is present due to an increase in inter-fibrillar interactions in spite of fibril-solvent interactions.

As previously mentioned, the SEM observation of the dried fibers showed a general increase in fibrillar alignment with smaller NID nozzles. This qualitative observation was confirmed from the image analyses performed. This analysis showed proportionally more intense and sharper bell distributions of fibril orientation when using thinner nozzles. This is coherent with a higher shear stress between the nozzle's internal wall and the solution during the extrusion process. Thus, this stress would consequently induce alignment in the solution prior to precipitation. Coherently, the conical geometry produced a lower shear stress and induced almost no fibrillar alignment along the extrusion direction. As mentioned, another feature observed with a strong correlation with the fibrillar alignment was the surface porosity and consequent exposed surface.

The cylindrical nozzles showed a fibril-fiber coherency below 16° (i.e., there was no more than 16° of angular divergence between the fibril orientation and the extrusion direction). This represents an almost complete alignment with the extrusion direction, considering a mild deviation in the analyses. Surprisingly, a mildly intense alignment was observed at about 60° from the extrusion direction in the “22 G con” specimens. This difference may arise from lateral forces applied on the solution due to the conical shape of the nozzle, before precipitation. These forces may have induced a mild variable vortical motion of the solution close to the nozzle tip, disrupting and modifying the solution fibril alignment and inducing a non-unidirectional orientation. This effect may be exploited to induce an alignment not along the extrusion direction, potentially coupling the conical nozzle with a rotational motion to get a finer adjustment.

At the microscopic level, a semi-periodically spaced wrinkled surface was observed. This morphology may be an artifact due to the dehydration of the samples and may not be present in the native wet scaffold. A qualitative correlation between the dimension of these wrinkles and the NID was observed, with larger wrinkles associated with a lower NID. This effect may arise from two possible effects: (i) a stop-slip effect during the printing due to partial solidification of the polymer at the edge of the nozzle tip, lightly blocking it, and leading to successive expulsion of the material by a local pressure increment; (ii) a higher flexural mechanical resistance of the surface due to increased fibrillar alignment and compaction, which would result in an impediment for the surface to fold into wrinkles. These wrinkles would also contribute to the alignment distribution in the image, sometimes inducing a significant broadening of the bell of distribution (i.e., 25 G specimen). For these cases, this contribution was limited by focusing on a smaller area where a reduced number of wrinkles is considered, highlighting the fibrillar alignment. Again, a difference was observed using the conical nozzle. This sample exhibited almost no transversal wrinkles, but instead showed less obvious ones parallel to the long axis of the fiber. This difference may arise from the conical shape of the nozzle, which would laterally compress the solution at the tip, where the solidification process starts to occur, inducing a folding of the fiber surface. Alternatively, it may be due to the different fibrillar orientation in this sample, which would shrink differently during dehydration.

The stress-strain profiles of the fibers under uniaxial tensile tests showed two different slopes, one in the initial range of the curve (up to 30% of strain) and a successively higher one until fiber breakage. This profile may be due to an initial contraction of the fiber diameter with water being extruded from the fiber followed by the actual displacement or stretching of the fibrils. A positive correlation between the fibrillar alignment in the fibers and their σmax and YM was observed. Coherently, about one third of the σmax and YM value was observed for “22 G con” compared to the 25 G sample, where two significant degrees of alignment were observed despite starting with a similar NID. This correlation showed how the final material resistance could be tuned by controlling the nanostructure of the fiber. Interestingly, no significant differences were observed in the εmax, meaning the fibrillar alignment may not be responsible for controlling the deformation of the material. Despite that, the fibers appeared quite elastic, showing a deformation of about 50%.

The 20 G and 27 G fibers were co-cultured with mammalian cells to evaluate the biocompatibility of the material. These fibers were chosen since they represent the two extremes in wet diameter and NID. Although the fiber manufacturing process was expected to introduce substances (i.e., HFIP) that inhibit cell growth, there was no effect on cell growth regardless of fiber size. Some cells were observed to localize in the vicinity of the material, suggesting that modification of the surface of the material promotes cell adhesion and can be used as a scaffold. These results demonstrate chitin's full biocompatibility; however, chitin does not induce a strong cell adhesion. For this reason, different methods have been developed to increase cell adhesion. Among these methods, collagen adsorption or coating was implemented. A first test of collagen adsorption was performed exposing the wet fiber to a collagen-rich solution for 24 h. The final matrix showed a significant increase of cell adhesion suggesting that this matrix could be further customizable after synthesis.

The results collected herein demonstrated that the chitin gel fibers obtainable with this novel methodology are easily customizable in dimension, fibrillar alignment, microarchitecture, and mechanical resistance while maintaining similar swelling, biocompatibility, and maximum strain. This customization was achieved using different NID during the extrusion.

Although this experiment only studied one variable, the method allows for a deep control over many different parameters, some of which are listed in FIG. 2. These parameters may be classified as initial solution conditions, physical factors, and precipitation constraints. Initial solution conditions include those related to the solvent (polarity, hydrogen bonding capability, etc.), the polymer material (molecular weight, crystallinity, etc.), and the solution preparation (concentration, viscosity, etc.). Physical factors include those related to the extrusion process, nozzle used (material, NID, shape, etc.), pressure, and eventual motion of the system (i.e., vibration or rotation of the nozzle). Finally, precipitation constraints include the counter solvent used (polarity, density, miscibility with the initial solvent, etc.) and its physical state (temperature, pressure, etc.). All of these different parameters could enable fine control of the material preparation, such as the shear stress applied on the solution, the rate of precipitation, or the solvent diffusion to or from the matrix during the precipitation. Finally, these control parameters could be expressed in a single-step additive manufacturing process that can potentially be expanded to any polymer. This technology could also be potentially translated into a 3D printing technology allowing for the production of 3D gel structures with specific properties. In addition, these fibers by themselves, or in 3D structures, could easily find application in biomedical fields such as in regenerative medicine, drug delivery, or the development of grafts or implantable devices.

As used herein, the term “about” refers to plus or minus 10% of the referenced number. Although there has been shown and described the preferred embodiment of the present invention, it will be readily apparent to those skilled in the art that modifications may be made thereto which do not exceed the scope of the appended claims. Therefore, the scope of the invention is only to be limited by the following claims. In some embodiments, the figures presented in this patent application are drawn to scale, including the angles, ratios of dimensions, etc. In some embodiments, the figures are representative only and the claims are not limited by the dimensions of the figures. In some embodiments, descriptions of the inventions described herein using the phrase “comprising” includes embodiments that could be described as “consisting essentially of” or “consisting of”, and as such the written description requirement for claiming one or more embodiments of the present invention using the phrase “consisting essentially of” or “consisting of” is met.

1. An additive manufacturing method to produce a biopolymeric material with tunable properties, the method comprising:
a. dissolving a biopolymer in a solvent to make a biopolymer solution comprising biopolymer molecules;
b. pre-aligning the biopolymer molecules in solution:
c. depositing the biopolymer solution; and
d. solidifying the biopolymer, thereby forming the biopolymeric material with tunable properties;
wherein one or more conditions from pre-alignment, deposition, or solidification are used to tune properties of the biopolymeric material.

2. The method of claim 1, wherein the biopolymer solution is deposited into a counter solvent or a supersaturated gas to solidify the biopolymer.

3. The method of claim 1, wherein the solvent is evaporated to solidify the biopolymer solution.

4. The method of claim 3, wherein heat or pressure is used to evaporate the solvent.

5. The method of claim 1, wherein pre-alignment is achieved by tuning a concentration of the biopolymers and/or the solvent, tuning a pressure applied to force the biopolymer solution through a nozzle, tuning a diameter of the nozzle and/or a geometry of the nozzle, or a combination thereof.

6. The method of claim 1, wherein the biopolymer molecules are pre-aligned in solution using shear flow, pressure, modified ionic strength of the solvent, or modified pH of the solvent.

7. The method of claim 1, wherein the biopolymer solution is deposited using 3D printing, extrusion, electrospinning, spin-coating, casting, or dip coating.

8. The method of claim 1, wherein the one or more conditions comprise chemical or physical properties of the biopolymer, properties of the biopolymer solution, geometry or mechanics of the additive manufacturing process, or a combination thereof.

9. The method of claim 8, wherein the chemical or physical properties of the biopolymer comprise molecular weight, molecular weight distribution, molecular branching, crystallite dimension, polymorphism, crystallinity, degree of substitution, or polarity.

10. The method of claim 8, wherein the properties of the biopolymer solution comprise viscosity of the solution or concentration of the biopolymer.

11. The method of claim 8, wherein geometry or mechanics of the additive manufacturing process comprise geometry of a nozzle, geometry of an extrusion hole of the nozzle, patterning of an inside surface of the nozzle, motion of the nozzle, pressure, or rate of extrusion.

12. The method of claim 1, further comprising additional modification of the biopolymeric material.

13. The method of claim 12, wherein the additional modification comprises dehydration, carbonization, adsorption, binding molecules to the material, or performing solvent exchange.

14. The method of claim 12, wherein the additional modification is performed before or during deposition of the biopolymer solution or after solidification of the biopolymer.

15. The method of claim 1, wherein the biopolymer comprises chitin, chitosan, cellulose, lignin, collagen, keratin, alginate, agarose, silk fibroin, polynucleotides, or a combination thereof.

16. The method of claim 1, wherein the solvent is an organic solvent, an aqueous solvent, or a combination thereof.

17. The method of claim 1, wherein tunable properties of the biopolymeric material comprise shape or morphology, fibril alignment, surface rugosity, density, porosity, exposed surface, crystallinity, solvent content, mechanical toughness, flexural stiffness, wear resistance, thermal resistance or conductance, electrical resistance or conductance, and/or light attenuation or conduction.

18. The method of claim 1, wherein the biopolymer solution further comprises additional components.

19.-43. (canceled)

44. A system for producing a biopolymeric material, comprising:
a. a biopolymer solution prepared by dissolving a biopolymer in a solvent, the biopolymer solution comprising biopolymer molecules;
b. a first vessel configured to contain the biopolymer solution;
c. a nozzle fluidically coupled to the first vessel, wherein the nozzle is configured to pre-align the biopolymer molecules as the biopolymer solution is passed through the nozzle;
d. a dispenser coupled to the nozzle;
e. a controller operatively coupled to the dispenser, the controller comprising a processor and a memory storing computer-readable instructions that, when executed by the processor, causes the dispenser to deposit the biopolymer solution through the nozzle at a desired flow rate and fiber length; and
f. a second vessel disposed below the nozzle for collecting the biopolymer solution after the biopolymer solution is deposited from nozzle, wherein the second vessel is configured to contain a counter solvent or a supersaturated gas for solidifying the dispensed biopolymer solution to produce the biopolymeric material;
wherein one or more conditions from pre-alignment, deposition, or solidification are used to tune properties of the biopolymeric material.

45.-46. (canceled)

47. A biopolymeric material prepared by a method comprising:
a. dissolving a biopolymer in a solvent to make a biopolymer solution comprising biopolymer molecules;
b. depositing the biopolymer solution such that the biopolymer molecules are pre-aligned; and
c. solidifying the biopolymer solution, thereby forming the biopolymeric material with tunable properties.

48.-53. (canceled)
